(19) United States
(12) Patent Application Publication
(10) Pub. No.: US 2015/0242747 A1
(43) Pub. Date: Aug. 27, 2015

(54) REAL ESTATE EVALUATING PLATFORM METHODS, APPARATUSES, AND MEDIA

(71) Applicant: Nancy Packes, Inc., New York, NY (US)

(72) Inventors: Nancy Packes, New York, NY (US); Emilien Benoit Manvieu, Arconnay (FR); Florin Talos, Terrebonne (CA)

(21) Appl. No.: 14/632,503

(22) Filed: Feb. 26, 2015

Related U.S. Application Data
(60) Provisional application No. 61/944,604, filed on Feb. 26, 2014.

(51) Int. Cl. G06N 3/08; G06N 3/04

(52) U.S. Cl. CPC G06N 3/08; G06N 3/04

(57) ABSTRACT

A unit type selection may be obtained and a training data set may be determined based on the unit type. A plurality of real estate value estimating neural networks may be trained using the training data set. A testing data set may be determined based on the unit type and the plurality of real estate value estimating neural networks may be tested on the testing data set. Based on the testing, a subset of the best performing neural networks may be selected to create a set of real estate value estimating neural networks. Each neural network in the set of real estate value estimating neural networks may be retrained on the worst performing subset of the training data set for the respective neural network.

This disclosure describes REAL ESTATE EVALUATING PLATFORM METHODS, APPARATUSES, AND MEDIA (hereinafter “REP”). A portion of the disclosure of this patent document contains material which is subject to copyright and/or mask work protection. The copyright and/or mask work owners have no objection to the facsimile reproduction by anyone of the patent document or the patent disclosure, as it appears in the Patent and Trademark Office patent file or records, but otherwise reserve all copyright and mask work rights whatsoever.

### CROSS-REFERENCE TO RELATED APPLICATION(S)

Applicant hereby claims priority under 35 U.S.C. §119 to U.S. provisional patent application No. 61/944,604, filed Feb. 26, 2014, entitled “REAL ESTATE EVALUATING PLATFORM METHODS, APPARATUSES AND MEDIA,” docket no. 2400-101PV.

The entire contents of the aforementioned application are herein expressly incorporated by reference in their entirety.

### FIELD

The present disclosure is directed generally to machine learning and pattern recognition.

### BACKGROUND

Valuation of real estate properties, such as apartment units, buildings, and commercial and office spaces, is used by real estate market participants in a variety of contexts. Sellers and landlords may wish to know how to price their real estate properties. Buyers may wish to know the value of a real estate property to guide their purchase decisions.

### BRIEF DESCRIPTION OF THE FIGURES

The accompanying figures, in which like reference characters may refer to like parts throughout, illustrate various exemplary embodiments in accordance with the present disclosure.

FIG. 1 shows a logic flow diagram illustrating a process for generating a set of neural networks (e.g., using a neural network generating (NNG) component) in accordance with some embodiments of the REP.

FIG. 2 shows a block diagram illustrating an exemplary neural network training module diagram in accordance with some embodiments of the REP.

FIG. 3 shows a screen shot diagram illustrating exemplary test results in accordance with some embodiments of the REP.

FIG. 4 shows a logic flow diagram illustrating a process for estimating value (e.g., using a real estate value estimating (RVE) component) in accordance with some embodiments of the REP.

FIG. 5 shows a logic flow diagram illustrating a process for predicting value (e.g., using a real estate value predicting (RVP) component) in accordance with some embodiments of the REP.

FIG. 6A shows a screen shot diagram illustrating an exemplary user interface in accordance with some embodiments of the REP.

FIG. 6B shows a screen shot diagram illustrating an exemplary user interface in accordance with some embodiments of the REP.

FIG. 7 shows a data flow diagram in accordance with some embodiments of the REP.

FIG. 8 shows a block diagram illustrating an exemplary REP coordinator in accordance with some embodiments of the REP.

FIG. 9 shows a logic flow diagram illustrating a process for evaluating a neural network in accordance with some embodiments of the REP.

FIG. 10 shows a logic flow diagram illustrating a process for determining a data set for use in generating a neural network in accordance with some embodiments of the REP.

### DETAILED DESCRIPTION

### Summary

The REP may be utilized to predict the pricing of (e.g., urban) real estate, both at the time of the inquiry, and into the foreseeable future. Existing pricing schemes are geared to the horizontal modes of development in suburban and rural real estate markets and are inaccurate in multi-family and hi-rise development markets such as exist in cities all around the world.

In some embodiments, the REP may be utilized to predict the value of individual apartment units for rental and sale, to predict the value of buildings, of neighborhoods, and/or of the whole market (e.g., as defined by any borough or boroughs with multifamily development). In some embodiments, the REP may be utilized to predict the value of commercial and office spaces (e.g., in vertical, or hi-rise, development structures).

In various embodiments, the REP may train, retrain, and utilize sets of neural networks to estimate values of real estate properties and/or to predict values of real estate properties into the future. In some embodiments, the REP may be utilized to predict other relevant data, such as direction of the market, time on the market, negotiation factor, and/or the like. A neural network or neuronal network or artificial neural network may be hardware-based, software-based, or any combination thereof, such as any suitable model (e.g., a computational model), which, in some embodiments, may include one or more sets or matrices of weights (e.g., adaptive weights, which may be numerical parameters that may be tuned by one or more learning algorithms or training methods or other suitable processes) and/or may be capable of approximating one or more functions (e.g., non-linear functions or transfer functions) of its inputs. The weights may be connection strengths between neurons of the network, which may be activated during training and/or prediction. A neural network may generally be a system of interconnected neurons that can compute values from inputs and/or that may be capable of machine learning and/or pattern recognition (e.g., due to an adaptive nature). A neural network may use any suitable machine learning techniques to optimize a training process. A suitable optimization process may be operative to modify a set of weights assigned to the output of one, some, or all neurons from the input(s) and/or hidden layer(s). A non-linear transfer function may be used to couple any two portions of any two layers (e.g., an input to a hidden later, a hidden layer to an output, etc.).

In various implementations, the REP may be accessed by a user via a website, a mobile app, an external application, and/or the like. In one implementation, the user may provide information regarding a real estate property of interest and/or regarding desired outputs. The REP may augment the information based on data regarding the property from a data store and/or may utilize one or more (e.g., cascading) sets of neural networks to determine the desired outputs. The desired outputs may be provided to the user.

For example, in some embodiments, an apparatus for generating a real estate value estimating neural network may include a memory and a processor in communication with the memory, and configured to issue a plurality of processing instructions stored in the memory, wherein the processor issues instructions to obtain by the processor a real estate unit type selection, determine by the processor a training data set based on the real estate unit type, wherein the training data set includes records associated with real estate properties of the real estate unit type, train by the processor a real estate value estimating neural network using the training data set, determine by the processor a testing data set based on the real estate unit type, wherein the testing data set includes records associated with real estate properties of the real estate unit type, test by the processor the real estate value estimating neural network on the testing data set, establish by the processor, based on the testing, that the real estate value estimating neural network's performance is not acceptable, determine by the processor the worst performing subset of the training data set, and retrain by the processor the real estate value estimating neural network on the worst performing subset of the training data set.

For example, in some embodiments, an apparatus for generating a set of real estate value estimating neural networks may include a memory and a processor in communication with the memory, and configured to issue a plurality of processing instructions stored in the memory, wherein the processor issues instructions to obtain by the processor a real estate unit type selection, determine by the processor a training data set based on the real estate unit type, wherein the training data set includes records associated with real estate properties of the real estate unit type, train by the processor a plurality of real estate value estimating neural networks on the training data set, determine by the processor a testing data set based on the real estate unit type, wherein the testing data set includes records associated with real estate properties of the real estate unit type, test by the processor the plurality of real estate value estimating neural networks on the testing data set, select by the processor, based on the testing, from the plurality of real estate value estimating neural networks a subset of the best performing neural networks to create a set of real estate value estimating neural networks, and retrain by the processor each neural network in the set of real estate value estimating neural networks on the worst performing subset of the training data set for the respective neural network.

For example, in some embodiments, an apparatus for evaluating real estate property value may include a memory and a processor in communication with the memory, and configured to issue a plurality of processing instructions stored in the memory, wherein the processor issues instructions to obtain over a network property attribute values associated with a real estate property, determine by the processor a real estate unit type based on the obtained property attribute values, select by the processor an appropriate set of real estate value estimating neural networks based on the real estate unit type, estimate by the processor component property values for the real estate property by using each neural network in the selected set of real estate value estimating neural networks to estimate a property value for the real estate property, and calculate by the processor an overall estimated property value for the real estate property based on the estimated component property values.

For example, in some embodiments, a computer system-implemented method of evaluating the performance of a neural network, wherein the computer system includes at least one processor component coupled to at least one memory component, may be provided where the method includes training, with the system, the neural network using each record of a first plurality of records, after the training, testing, with the system, the neural network using each record of a second plurality of records, wherein the second plurality of records includes at least the first plurality of records, defining, with the system, a proper subset of the first plurality of records based on the testing, and re-training, with the system, the neural network using each record of the proper subset of the first plurality of records.

For example, in some embodiments, a non-transitory computer-readable medium may include computer-readable instructions recorded thereon for training, with a processing system, a neural network using each record of a first plurality of records, after the training, testing, with the processing system, the neural network using each record of a second plurality of records, wherein the second plurality of records includes at least the first plurality of records, defining, with the processing system, a proper subset of the first plurality of records based on the testing, and re-training, with the processing system, the neural network using each record of the proper subset of the first plurality of records.

For example, in some embodiments, a computer system-implemented method of defining a data set for use in generating a neural network with a particular network differentiator, wherein the computer system includes at least one processor component coupled to at least one memory component, may be provided where the method includes accessing a plurality of data records, selecting a first subset of records from the plurality of data records, wherein each record of the first subset of records includes a value for a first particular attribute type that is within a first particular value range, selecting a second subset of records from the first subset of records, wherein each record of the second subset of records includes a value for a second particular attribute type that is within a second particular value range, and defining at least a subset of the second subset of records as a training data set for use in training the neural network.

For example, in some embodiments, a non-transitory computer-readable medium may include computer-readable instructions recorded thereon for accessing, with a processing system, a plurality of data records, selecting, with a processing system, a first subset of records from the plurality of data records, wherein each record of the first subset of records includes a value for a first particular attribute type that is within a first particular value range, selecting, with a processing system, a second subset of records from the first subset of records, wherein each record of the second subset of records includes a value for a second particular attribute type that is within a second particular value range, and defining, with a processing system, at least a subset of the second subset of records as a training data set for use in training a neural network.

For example, in some embodiments, a system may include a feedforward neural network configured to receive feedforward inputs and generate a feedforward output, and a recurrent neural network configured to receive a plurality of recurrent inputs and generate a recurrent output, wherein one of the recurrent inputs of the plurality of recurrent inputs includes the feedforward output, the feedforward output is an estimated value of an item for one of a current time and a previous period of time, and the recurrent output is a predicted value of the item for a future period of time.

### DETAILED DESCRIPTION OF THE REP

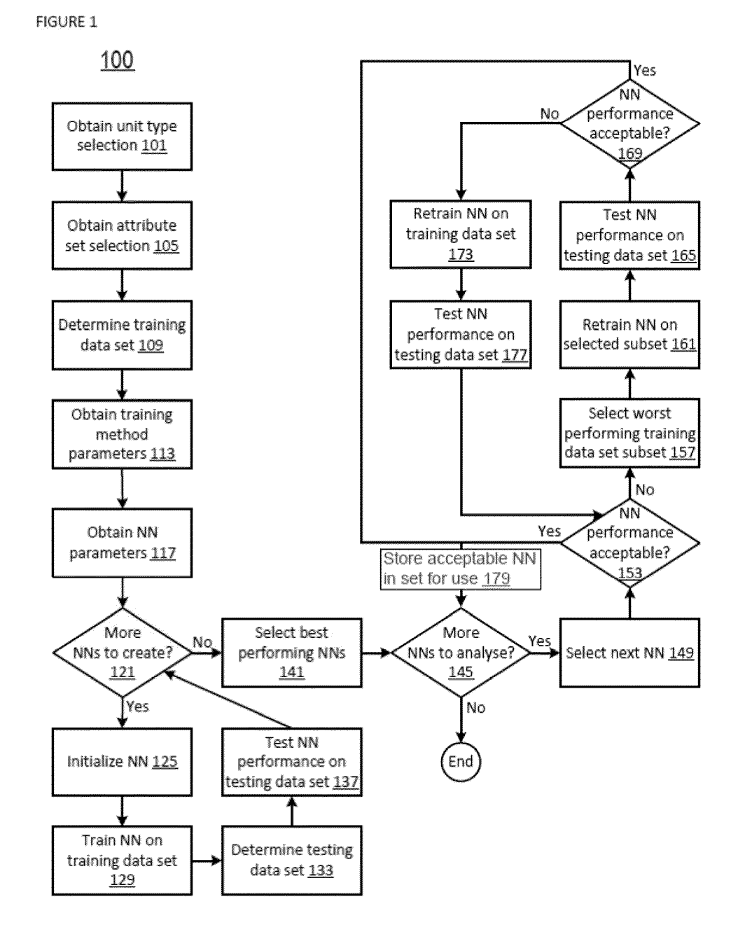

FIG. 1 shows a logic flow diagram illustrating a process 100 for generating a set of neural networks (e.g., using a neural network generating (NNG) component) in accordance with some embodiments of the REP. FIG. 1 provides an example of how a set of neural networks for estimating values (e.g., property prices, rental prices, etc.) of real estate properties may be generated. In one implementation, a software application for design and development of neural networks may be utilized (e.g., as and/or by the REP) to facilitate generating the set of neural networks of process 100. In FIG. 1, a unit type selection may be obtained at step 101 of process 100. For example, a unit type may be condominium, cooperative, commercial unit, family house, townhouse, loft, rental or sale (e.g., for any unit type), multi-unit building, and/or the like. In one implementation, the unit type selection may be obtained from a REP administrator or any other suitable party via an appropriate graphical user interface (GUI) of the REP. The unit type selection may indicate the type or types of real estate properties for which values may be estimated by the set of neural networks. In one embodiment, a different set of neural networks may be utilized for each unit type to estimate values of real estate properties of that unit type. Accordingly, one set of neural networks may be utilized to estimate property values for condominiums, another set of neural networks may be utilized to estimate property values for commercial units, another set of neural networks may be utilized to estimate property values for multi-unit buildings, another set of neural networks may be utilized to estimate property values for rentals of any unit type while another set of neural networks may be utilized to estimate property values for sales of any unit type, etc.

An attribute set selection may be obtained at step 105 of process 100. In one embodiment, real estate properties may have different attributes based on the unit type. For example, a condominium may have different attributes compared with a commercial unit (e.g., a condominium may have a “pool” attribute, but this attribute may have no meaning for a commercial unit). In another example, a multi-unit building may have attributes that may not be applicable to other types of units (e.g., number of units in the building). In some implementations, an attribute set may be selected from any suitable attributes that include, but are not limited to, the following:

UnitType
City
ZIP
State
Neighborhood
Sqft
CostPerSqft
Bedrooms
Library
DiningRoom
DiningArea
HomeOffice
Closed kitchen
Terrace
Bathrooms
TotalRooms
Maintenance
FloorNo
MonthSaleDate
Taxes
YearBuiltBuilding
YearAlteredBuilding
NumberOfFloorsBuilding
NumberOfUnitsBuilding
ConstructionCostPerUnit
HeightBuilding
LandValueEstimate
Amenities
24/7 Concierge
Doorman
Hotel Services
Valet Service
Residents Lounge
Fitness Center
Ball Court
Swimming Pool Indoor
Swimming Pool Outdoor
Spa Facilities
Residents Only Restaurant
Resident's Dining Room
Business Center
Movie Screening Room
Children's Playroom
Pet Spa
Wine Storage
Personal Storage
Bicycle Storage
In house garage
Roof deck
Landscaped Outdoor Space
Outdoor Movie Screening
Golf Simulator
Washer/dryer

In some implementations, an attribute set may be selected from attributes that include information regarding repairs, modernizations, and/or the like investments (e.g., in the last 20 years) associated with a building or other real estate property, information regarding retrofit costs calculated in order for a building to become compliant with local seismic regulations, information regarding building life cycle costs (e.g., energy costs), information regarding building operating expenses, information regarding potential income that is estimated based on unit rental prices and variations in rate of occupancy (e.g., in the last 20 years) in a multi-unit building, information regarding estimated values of each unit in a multi-unit building, and the like. In some implementations, an attribute set may be selected from attributes that include any other suitable type of useful historical data.

In one embodiment, the attribute set selection may be automatically obtained based on the unit type selection. In one implementation, any attribute associated with the unit type may be selected and used as individual or group inputs during training and/or retraining (e.g., at one or more of steps 129/161/173 described below). For example, based on the type of the property, the REP may be operative to use different attributes for training (e.g., a doorman may not be an amenity for a house, but may be an amenity for a condo). Multiple neural networks may be trained on different sets of attributes and may be based on the user input, while the REP may be operative to select the proper set of neural networks to be trained for a particular set of attributes. As mentioned, a grouping process may be employed to group multiple attributes (e.g., attributes with a low importance factor) to create a single new attribute with a higher importance factor or importance index value). In another implementation, each attribute associated with the unit type may be evaluated (e.g., using data mining techniques based on neural network output error screening, neural network classification, and/or the like) to identify the attribute's capacity to lower the output error associated with property value estimates, and an importance factor or importance index value proportional to the identified capacity to lower the output error may be assigned to the attribute (e.g., the importance factor may be stored in an importance index in a data store). As just one example, the REP may be operative to start the training of a neural network with a hypothesis that all inputs have the same importance factor, where, the REP may keep the same number of inputs and may repeat the training process using the same neural network architecture, data set, training methods, and parameters, but may use different attributes as inputs. For each set of inputs, multiple testing processes may be conducted in order to minimize the impact of the initial random matrix initialization in the training process. By testing the neural networks, different performances based on the different set of inputs used in the training process may be observed. Based on these observed results, the REP may be operative to create importance factors for each or at least some of these different characteristics or attributes as inputs. The values of these importance factors may be stored in an importance index that may be associated with a particular type of property unit type and/or any other particular network differentiator such that when a neural network is to be generated for such a particular network differentiator (e.g., property unit type with or without other differentiator(s), such as price, square footage, etc.), the importance index for that particular network differentiator may be leveraged for determining what attributes of available records may be used as inputs for training and/or testing such a neural network, where such importance factors may depend on the unit localization (e.g., downtown vs. suburbs) and type of estimation (e.g., rental vs. sale) or any other suitable variables. Attributes with high capacity to lower the output error (e.g., the importance factor is above a specified threshold, the importance factor is above average, etc.) may be selected and used as individual inputs during training and/or retraining (e.g., at one or more of steps 129/161/173 described below). Attributes with higher importance or weight may be used by the REP in priority over other attributes when training a particular type of neural network for a particular use. If, for example, the REP is to create a neural network using only 5 inputs, the REP may be operative to select or receive a selection of 5 inputs with the highest importance factor for that neural network type. Such a limitation of the number of inputs may be dictated, for example, by any suitable information provided by a user in an estimation process enabled by the REP. For example, when a user asks for an evaluation of a unit, the REP may be operative to first attempt to identify information about that unit in a database (e.g., a historical database) to obtain the unit attributes. If the information is missing, the REP may rely on user input and for evaluation needs may find a neural network trained for that specific set of attributes. Attributes with low capacity to lower the output error (e.g., the importance factor is below a specified threshold, the importance factor is below average, etc.) may be either not selected, or selected and grouped into one or more group inputs (e.g., an attribute may be grouped with similar types of attributes into a group input) and used as a part of one or more group inputs during training and/or retraining (e.g., at one or more of steps 129/161/173 described below), where such a grouping process may, for example, reduce network complexity by using a lower number of inputs with higher importance factors. For example, sports amenities, such as whether there is a swimming pool, whether there is a fitness center, whether there is a ball court, and the like, may be grouped into one group input. In another example, storage amenities, such as whether there is wine storage, whether there is personal storage, whether there is bicycle storage, and the like, may be grouped into another group input. For example, grouping attributes with low importance factors may facilitate faster neural network training and/or retraining speed (e.g., by grouping attributes with low importance factors, the REP may be operative to improve the training performances without increasing the resources used (e.g., time, memory, and processor requirements)). For example, by combining multiple low importance factor “sports” amenity attributes, such as three sports amenities for “swimming pool?”, “gym?”, and “track?” into a single high importance factor “combined sports amenities” attribute, the value of such a high importance factor grouped or combined attribute may be operative to reflect the properties of each low importance factor attribute of the group (e.g., if each of the three importance factor weight attribute's property was “yes”, the value of the grouped attribute may be a 9 (e.g., the highest value), whereas if none of three low importance factor attribute's property was “yes”, the value of the grouped attribute may be a 0 (e.g., the lowest value), alternatively, if any of the three low importance factor attribute's property was “yes”, the value of the grouped attribute may be a 9 (e.g., the highest value), whereas if none of three low importance factor attribute's property was “yes” or even available in the data set, the value of the grouped attribute may be a 0 (e.g., the lowest value)). In yet another implementation, a subset (e.g., a strict or proper subset) of attributes that most influence property value estimates may be determined (e.g., using data mining techniques) and such attributes may be selected. For example, utilizing such a subset of attributes may facilitate faster neural network training and/or retraining speed. While the REP may not be ignoring or removing any attributes, different neural networks may be trained on different numbers and/or types of attributes (e.g., to adapt on the variable number of user inputs that may be provided during use of that neural network by a user (e.g., for estimation or prediction)). In some embodiments, there may be little to no benefit in using attributes with very low importance (e.g., if the performances of a neural network trained with 40 inputs is similar to the performances of a neural network trained with 20 inputs, the REP may be operative to use the latter neural network). For example, there may be at least two main reasons for configuring the REP to avoid training a neural network with a large number of inputs, such as, (1) increased processing time and resource consumption, and (2) the difficulty with which it may take to obtain usable data for a large number of inputs for one or more units. Very often this information may be missing in the data sources and/or a user cannot provide this quantity of information during a use case process. In another embodiment, the attribute set selection may be obtained from the administrator or any other suitable party via an appropriate GUI of the REP. For example, the administrator may select a subset (e.g., a strict or proper subset) of attributes from attributes associated with the unit type. In one implementation, a minimum and/or a maximum number of attributes for the attribute set may be specified (e.g., at least 25 attributes, at most 50 attributes). The set of neural networks may be created, trained, and tested using the selected set of attributes. The REP may be operative to create a list of importance factors for each parameter that may influence the network performances. A higher number of input parameters that define the real estate property characteristics may increase the chances of the neural network finding patterns inside of these characteristics. Not all parameters may have equal importance in the training process. Some parameters may be more relevant than others in the pattern recognition process. Parameters with more relevance may significantly lower the training process error, which may increase the neural network performance. Increasing the number of input parameters may also increase the need for power computation. The training process may utilize more resources and time to process the increased number of parameters for the same data set. The REP may be operative to analyze the importance of the input parameters by assigning an importance factor for each parameter. The training process may use the optimal set of input parameters in order to achieve maximum performances with minimum utilization of time and hardware resources. In some embodiments, if attributes available for selection change significantly (e.g., a predetermined number of attributes are added after the set of neural networks was generated by process 100), the set of neural networks may be re-generated based on updated attributes (e.g., by repeating at least a portion of process 100).

A training data set may be determined at step 109 of process 100. In one embodiment, historical data regarding real estate properties (e.g., from the data sets data store 830d described below) may be analyzed and a training data set for the selected unit type may be selected (e.g., via one or more structured query language (SQL) queries) based on that analysis. For example, historical property records data (e.g., including data regarding property characteristics, neighborhood characteristics, geographic localization, transactions data, trends data, economic data, and/or the like) for the selected unit type with data for the selected set of attributes may be selected (e.g., automatically). Historical data may contain the transactions recorded on a specific unit but also the description of the building and the unit. By importing multiple transactions about the same unit, the REP may be operative to complete missing information to correct inaccurate information or to apply changes to the unit characteristics (e.g., a unit was transformed from 3 bedrooms to only 2 bedrooms). The REP may be operative to generate a neural network based on the number of attributes for a list of units available today in the database, but, in a week after another data import may bring new attributes, the REP may be operative to generate another neural network with a different set of inputs. In some implementations, property records for the training data set may be selected based on locale and/or price variation. A property record may be associated with a locale (e.g., a neighborhood) and a locale may have an associated price variation (e.g., a minimum and a maximum price associated with real estate properties of the selected unit type, a price range calculated as the difference between a maximum and a minimum price associated with real estate properties of the selected unit type, etc.). Property records of locales with similar price variations may be grouped and used as the training data set. For example, property records for neighborhoods with similar minimum and maximum prices may be grouped and used as the training data set. Accordingly, a different set of neural networks may be utilized for each group of neighborhoods to estimate values of real estate properties of the selected unit type in that group of neighborhoods. There may be different neural networks for different units and different sets of inputs for a single locale. For example, there could be a set of neural networks dedicated to condos with 1 to 4 bedrooms for location 1 and a set of neural networks dedicated to houses with 1 to 5 bedrooms for the same location 1. In some embodiments, similarity of locales may be determined based on statistical techniques. For example, two locales may be grouped if the percentage difference between their minimum prices does not exceed a first threshold and/or the percentage difference between their maximum prices does not exceed a second threshold. In another example, two locales may be grouped if the percentage difference between their average prices does not exceed a first threshold and/or the percentage difference between their price standard deviations does not exceed a second threshold. In some embodiments, a minimum (e.g., 2 locales) and/or a maximum (e.g., 25 locales) number of locales that may be grouped may be specified (e.g., by a configuration setting, by the administrator via the GUI, etc.). In some implementations, property records for the training data set may be selected based on attribute value ranges. Such selection and/or such configuration may be done by an administrator of the REP. For example, such processes may be executed unattended but may be designed, scheduled, and/or monitored by a system administrator. The REP may be fully configured by when an end user attempts to use the REP for an end user process (e.g., an estimation or prediction). For example, property records of real estate properties (e.g., from a group of locales) of the selected unit type that have between 3 and 5 rooms may be selected and used as the training data set. In another example, property records of real estate properties of the selected unit type that are between 500 and 1,000 square feet may be selected and used as the training data set. In yet another example, property records of real estate properties of the selected unit type that were built after 1945 may be selected and used as the training data set. Accordingly, a different set of training data may be utilized for each set of specified attribute value ranges to help generate a neural network to estimate values of real estate properties having such a set of attribute value ranges. In one implementation the evaluation process for determining an appropriate data set (e.g., at step 109) may use data from a limited number of neighborhoods or locales. The training of the neural networks may be a supervised process. Defined as an output value, during the training process, the estimated unit value may be comparted against the sale price (e.g., as described below, such as with respect to step 137). The goal of the training process may be to teach a neural network for pattern recognition. The best performances may be achieved with neural networks that may be specialized in the recognition of a limited number of patterns (e.g., a limited variation of the sale price). The unit localization may be one of, if not the, most important factors in sale price variation. By grouping and limiting the number of neighborhoods, the sale price for the units can be limited to a smaller range. For best training performances, the groups may be kept as small as possible. Larger neighborhood groups may require less specialized neuronal networks and may lower the system maintenance. If the unit price variation is very limited, a larger number of neighborhoods can be selected with the same or even better training performances. Through analyzing the dependency between a network's performances and variation of the output, it has been an unexpected result that limiting the number of patterns that a neural network must recognize may drastically improve the neural network's performances. By limiting the number of characteristics that a neural network must identify for each pattern may also considerably improve the performances. That is, training a specialized neural network may result in one or a set of neural networks with high performances that may be very capable to recognize the patterns trained therefor. Based on this unexpected conclusion, the REP may create a neural network trained on units with similar characteristics and a limited range for the output supervised value (e.g., price value). By limiting the number of patterns that a neural network may be generated to identify may increase the performances of that neural network. A more specialized neural network may be operative to give better results than a neural network trained for any/all type(s) of units.

In one implementation, historical data may be collected (e.g., continuously, periodically, etc.) from a plurality of sources such as an Automated City Register Information System (ACRIS), the Department of Buildings of the City of New York, Building Owners' and Brokers' web sites, the New York State Attorney General's Office, the Public Library, Federal Energy Management Program, real estate news publications, and/or the like. Such data may include property characteristics, neighborhood characteristics, geographic localization (e.g., state, city, borough, area, neighborhood, etc.), transactions data (e.g., transaction date, listed price, sold price, days on the market, description, etc.), trends data (e.g., seasonal and/or annual price change trends, average days on the market, information concerning supply and demand for real estate, etc.), economic data (e.g., consumer confidence levels, gross domestic product, interest rates, stock market values, anticipated future housing supply levels, wage growth, etc.), and/or the like. In some embodiments, if historical data utilized by the REP to generate a set of neural networks changes significantly (e.g., a predetermined percentage of data in the data sets data store 830d changes due to data obtained after the set of neural networks was generated), the set of neural networks may be re-generated using updated historical data (e.g., at least a portion of process 100 may be repeated).

In one implementation, before it is used (e.g., as inputs, as outputs, etc.), historical data may be prepared to reduce property value variation associated with time. For example, reducing property value variation associated with time (e.g., inflation, housing market trends, etc.) in historical data may lead to better results when training and/or retraining a neural network to estimate property value based on differences in attribute values. In one embodiment, to prepare historical data, historical property values (e.g., historical prices) may be analyzed to determine property values as of a specified (e.g., current) time period. In one implementation, historical data may be prepared using the following preparation process. An estimation time period unit (e.g., one month) may be defined. Historical data may be obtained for a specified estimation time frame (e.g., the last year) for properties that have data regarding property values during the estimation time frame (e.g., properties that were sold during the last year and have a selling price, properties whose property values were evaluated during a previous preparation iteration, etc.). The obtained historical data may be sliced for each estimation time period (e.g., for each month during the last year). For each slice of the obtained historical data, a first set of neural networks may be generated (e.g., using the NNG component and process 100) using the slice as a data set, and the best performing subset (e.g., a strict or proper subset) of the data set may be determined (e.g., 10% of records for which the first set of neural networks gives the smallest output error (e.g., at step 141)). Properties comparable (e.g., based on similarity of attribute values) to the best performing subset of the data set may be evaluated using the first set of neural networks to estimate property values for the time period (e.g., for the month) associated with the slice. A prediction time period unit (e.g., one month) and a prediction time frame (e.g., three months) may be defined. A second set of neural networks may be generated to predict property values in the next time period (e.g., property values for the fourth month) based on property values (e.g., historical prices, estimated property values for the slices, etc.) associated with the prediction time frame (e.g., property values during the preceding three months). The second set of neural networks may be used to predict property values based on data for each prediction time frame during the estimation time frame (e.g., property values may be predicted based on data for each sliding three month period during the last year) for properties that have data regarding property values during the prediction time frame. The preparation process may be repeated until desired data density is obtained (e.g., there is sufficient data for the specified time period). For example, prepared historical data with property values as of the specified (e.g., current) time period may be used (e.g., as inputs, as outputs) when training and/or retraining the set of neural networks. Such a slicing process may be utilized by the REP (e.g., for a prediction process). The REP may be operative to find patterns not only on the input space described by the unit attributes but also in time defined by the price variation in the past. In order to predict the price variation in the next future (e.g., 3-6 months), the REP may be operative to leverage the price variation from the past, yet such information may not always be available (e.g., as missing data or simply because one unit was sold one time in the last 5 years). To make up this potential deficiency, the REP may be operative to use a set of neural networks to estimate the sale price for a unit at a specific point in time trained on data from the same time period. With a good representation (e.g., based on the estimated missing sale values) in time, the prediction system using recurrent neuronal networks, for example, may be trained to predict the price evolution for the future.

In one implementation, property records with missing attribute values may be filtered out. In another implementation, property records with missing attribute values may be used and default values (e.g., typical attribute values for similar properties) may be substituted for the missing attribute values. In one implementation, a minimum and/or a maximum size for the training data set may be specified (e.g., at least 1,000 records, at most 60,000 records, etc.). In some implementations, usable records (e.g., those that passed selection criteria) may be split among the training data set and a testing data set. For example, usable records may be split such that a predetermined proportion of records (e.g., approximately 30%, between 10% and 50%, approximately 70%, etc.) is used for the training data set and the remaining records are used for the testing data set. In some embodiments, the selection of the records for training versus testing may be done randomly by the REP. The percentage between training and testing may be based on the amount of data available. Different data sets can be used for training and testing and, in such a case, each data set may be used for training and testing.

In one implementation, historical data may be validated and/or cleaned before it is used (e.g., as inputs, as outputs). For example, if an attribute has an incorrect value (e.g., similar properties but one property record has square footage value that is ten times bigger than other similar properties), the incorrect value may be replaced with a correct value (e.g., if the correct value can be obtained) or with a default value (e.g., typical attribute value for similar properties). In another example, property records with incorrect and/or missing attribute values may be removed from the data store and/or filtered out during training data set determination. In one implementation, attribute values may be analyzed to determine other attribute values. For example, the “unit number” attribute value may be analyzed to determine the “floor number” attribute (e.g., by analyzing the string representing the unit number as follow: #11, #11D, #11DN, #E11G means 11^{th} floor, #B, #B5, #B13 means 2^{nd} floor, etc.). In another example, the “floor number” attribute may be analyzed (e.g., to estimate the floor height in a building) to determine the value (e.g., has view, does not have view) of a property's view. In some embodiments, an algorithm based on text parsing methods (e.g., regular expression and/or sq1 queries) may be used by the REP for such purposes.

In one implementation, attribute values may be converted into numerical values (e.g., using referential tables). For example, each city may be associated with a unique number. In another example, construction year may be assigned a number as follows: <1940: 0.5, 1941-1970: 0.9, 1971-1980: 1.125, 1981-1990: 1.2, >1991: 1.3. In one implementation, attribute values may be normalized. For example, numerical values may be converted to a 0 to 1 interval, where 1 is equivalent to the biggest original value and 0 is equivalent to the smallest original value.

Training method parameters may be obtained at step 113 of process 100. In one implementation, the training method parameters may be obtained from the administrator or any other suitable party via any suitable GUI of the REP. In another implementation, the training method parameters may be obtained from a configuration file. The REP may be operative to receive (e.g., from a system administrator at an administrative module) or otherwise access training parameters (e.g., number of hidden layers, number of neurons in each hidden layer, training methods, epoch number, etc.). Based on the neural network performances, some of these parameters may be saved in the database (e.g., not in the configuration files) and automatically reused for other training being considered by the REP as effective. For example, the obtained training method parameters may include a selection of one or more training methods (e.g., Resilient Propagation, Levenberg, etc,) to use for training and/or retraining the set of neural networks. Alternative training methods may be utilized during the same training session when the primary training method is no longer improving a neural network's performance (e.g., using a combination of training methods may help escape a local minimum and result in further improvement of the neural network's performance). For example, a first method may be used for training and a second method may be used for retraining during the same process using the same data set(s) (e.g., a condition may be defined by the REP that, if during the last 5 epochs, there is no improvement (e.g., the training error is not minimizing), the REP may be operative to change the training method and start retraining of the network with a different method). In another example, the obtained training method parameters may include the number of epochs to use (e.g., the number of cycles the algorithm will work on trying to minimize the output error by changing the weights matrix, such as 250,000 epochs, which may be different for different neural networks) for training and/or retraining the set of neural networks. In yet another example, the obtained training method parameters may include the maximum acceptable error (e.g., average difference between estimated property value and actual property value for properties in a testing data set, such as 5%) for a neural network in the set of neural networks. In yet another example, the obtained training method parameters may include the number of neural networks (e.g., 10 neural networks to create initially, 5 best performing neural networks to select for further analysis and/or retraining, etc.) for the set of neural networks (e.g., as may be described below with respect to step 141).

Neural network parameters may be obtained at step 117 of process 100. In one implementation, the neural network parameters may be obtained from the administrator or any other suitable party via any suitable GUI of the REP. In another implementation, the neural network parameters may be obtained from a configuration file. All the parameters may be saved in a database. When a network is trained, all the information about this process may be saved in the database (e.g., the training parameters, the data set used, the network performances, training execution time, all the testing results for that specific network with results for each record, etc.). For example, the neural network parameters may include the number of neurons in the input layer (e.g., defined by the number of inputs, such as the number of attributes in the attribute set). In another example, the neural network parameters may include the number of hidden layers (e.g., 1 hidden layer) and/or the number of neurons per hidden layer (e.g., one neuron more than the number of neurons in the input layer, between 1 and 10 times the number of neurons in the input layer, etc.). A smaller number of neurons per hidden layer may speed up training and/or may provide a wide variation of results, while a larger number of neurons per hidden layer may result in a smaller training error and/or may provide more constant training performance (e.g., less variation of results). In yet another example, the neural network parameters may include the number of neurons in the output layer (e.g., 1 neuron representing an output (e.g., the estimated property value)).

A determination may be made at step 121 of process 100 whether there are more neural networks to create. For example, 10 neural networks may be created initially. If there are more neural networks to create, the next neural network may be created and initialized at step 125 of process 100. A bulk training process may also be enabled by the REP. When analyzing network training performances, the REP may be operative to execute multiple times the process with the same configuration to limit the impact of random generation of the weights matrix. Bulk training features may be operative to generate a set of neural networks using the same training data set and parameters. The condition to stop the bulk training process may be based on the number of generated neural networks or based on a limit on the training error, for example. In one implementation, the neural network may be initialized using a randomly created weights matrix (e.g., during the first epoch). During following epochs, such a matrix may be adjusted basted on the results of the previous epoch. Because the start of a training algorithm may be random, the results of two successive networks may not be the same. With a better starting condition, the final result may be improved. During a training process, the weights assigned to the connection between neurons may be adjusted in order to minimize the training error. When the training process starts, those matrices may be randomly initiated.

The neural network initialized at step 125 may be trained on the training data set at step 129 of process 100. For example, the neural network may be trained in accordance with the selected training method (e.g., Resilient Propagation) of step 113. In one implementation, the weights matrix may be adjusted in subsequent epochs based on the results of the previous epoch. In some embodiments, if the neural network's performance is not improving (e.g., after a predetermined number of epochs), the training may be stopped. In some embodiments, if the neural network's performance is not improving (e.g., after a predetermined number of epochs), the weights matrix may be reinitialized.

A testing data set may be determined at step 133 of process 100. In one embodiment, the testing data set may be determined in a similar manner as discussed with regard to training data set determination of step 109. For example, usable records may be split such that a predetermined proportion of records (e.g., approximately 30%, between 10% and 50%, approximately 70%, etc.) is used for the training data set and the remaining records are used for the testing data set. In another embodiment, the testing data set may at least include each record of the training data set if not additional records as well. In other embodiments, the testing data set may include at least one of the records of the training data set. The final evaluation of a neural network may be done by testing the results on one or more data records never used during the training of that neural network. In some implementations, like progressive retraining, a neural network can be tested on the same records as used in the training. The purpose of this may be to highlight worst performing records in order to create another data set. Also during a training session, (e.g., once every 100 epochs) the REP may be operative to test a neural network on the same training data set in order to give a human understanding of the evolution of the training. When testing a neural network, a data set may have the same structure as the one used for training (e.g., same number of inputs and the same input types).

The neural network's performance may be tested on the determined testing data set of step 133 at step 137 of process 100. In one implementation, since each network may be initialized using a randomly created weights matrix, the results provided by different neural networks may differ (e.g., neural networks with better initial weights matrix may produce better results). In one embodiment, the neural network may be used to estimate a property value for each record in the testing data set. The estimated values may be compared to actual property values to calculate the percentage error (e.g., average of percentage errors for properties in the testing data set (e.g., the percentage error for each record in the testing data set may be determined, and the average of the percentage errors of all records in the testing data set may be determined). After step 137, process 100 may return to step 121.

In some embodiments, when it is determined at step 121 that no more neural networks are to be created, the best performing neural networks may be selected at step 141 of process 100 and kept for further analysis and/or retraining. For example, the 5 best performing (e.g., having the smallest percentage error, as may be determined for each neural network at step 137) neural networks may be selected for further analysis and/or retraining.

A determination may be made at step 145 of process 100 whether there are more best performing neural networks to analyze. For example, each of the best performing neural networks selected at step 141 may be analyzed. If there are no more best performing neural networks to analyze, process 100 may end or repeat (e.g., at step 101). However. if there are more best performing neural networks to analyze, the next best performing neural network may be selected for analysis at step 149 of process 100.

A determination may be made at step 153 of process 100 whether the selected neural network's performance is acceptable. For example, the percentage error associated with the selected neural network's performance (e.g., as may be determined at step 137) may be analyzed to determine whether it is below a specified threshold level (e.g., the maximum acceptable error). If the selected neural network's performance is acceptable, the selected neural network may be stored at step 179 of process 100 for use as part of the set of neural networks.

If the selected neural network's performance is not acceptable, the worst performing subset (e.g., a strict or proper subset not equal to the complete training data set) of the training data set may be selected at step 157 of process 100. This may be utilized as at least a portion of a recursive retrain process of the REP. The selection of the worst performing subset may be based on the testing error or any other suitable criteria. After the training, a testing process may be executed for each of the records in the training data set. The averaged error may be calculated and all the records with an error higher than the average error may be selected for use in a new subset. The same neural network may then be retrained on this subset and the neural network may then again be trained on the main data set, where such a process may be repeated for a suitable number of cycles. In one embodiment, records in the training data set for which the selected neural network gives above average error may be selected. In another embodiment, a predetermined percentage (e.g., 20%) of records in the training data set for which the selected neural network gives the largest error may be selected. The selected neural network may be retrained on the selected subset of the training data at step 161 of process 100. In one embodiment, the selected neural network may be retrained in a similar manner as discussed with regard to step 129 of process 100. For example, the same (e.g., Resilient Propagation) or different (e.g., Levenberg) training method may be used to retrain the selected neural network at step 161. Changing the training method may be useful in avoiding or escaping from a dead-end training process. Neural network training may be based on one or more suitable algorithms operative to find a global minimum for a non-linear function and, sometimes, such an algorithm may get stuck to a local minimum. In one implementation, the number of epochs used to retrain the selected neural network at step 161 may be smaller (e.g., 20% of) than the number of epochs used to train the selected neural network at step 129 to avoid making excessive changes to the selected neural network. When retraining a neural network, at least some or all of the parameters that define the neural network architecture stay the same (e.g., number of inputs, number of hidden layers, number of neurons per hidden layer, etc.), where only the training data set and/or training parameters may be changed by the REP.

The selected neural network's performance may be tested on the testing data set at step 165 of process 100. In one embodiment, the selected neural network may be tested in a similar manner as discussed with regard to step 137. In a progressive retrain process, the REP may be operative to test a neural network against the same data set used for training that network in order to define the worst performing subset. The cycle may stop when the testing error of the neural network tested on the same training data set is not improving anymore and/or when a neural network testing conducted on a different data set from the one used for training results in a testing error equal to and/or lower than the one accepted for the system (e.g., 5%). A determination may be made at step 169 of process 100 whether the selected neural network's performance is acceptable. For example, the percentage error associated with the selected neural network's performance (e.g., as may be determined during the testing of step 165) may be analyzed at step 169 to determine whether it is below a specified threshold level (e.g., the maximum acceptable error (e.g., the same error that may be used at step 153 and/or at step 141)). If the selected neural network's performance is acceptable, the selected neural network may be stored at step 179 of process 100 for use as part of the set of neural networks.

If the selected neural network's performance is determined at step 169 to be not acceptable, the selected neural network may be retrained on the training data set at step 173 of process 100. In one embodiment, the selected neural network may be retrained in a similar manner as discussed with regard to the initial training of step 129. In one implementation, the number of epochs used to retrain the selected neural network at step 173 may be smaller (e.g., 20% of) than the number of epochs used to train the selected neural network at step 129 to avoid making excessive changes to the selected neural network.

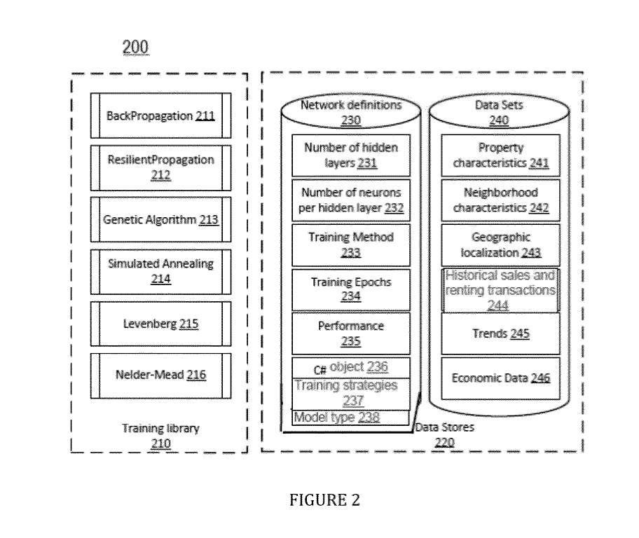

The selected neural network's performance may then be tested on the testing data set at step 177 of process 100. In one embodiment, the selected neural network may be tested in a similar manner as discussed with regard to step 137 and/or step 165. If the selected neural network's performance is acceptable (e.g., as may be determined at step 153), the selected neural network may be stored at step 179 of process 100 for use as part of the set of neural networks. Otherwise, the retraining cycle of some or all of steps 157-177 may be repeated. In one implementation, the retraining cycle may be repeated until the selected neural network's performance is acceptable. In another implementation, the retraining cycle may be repeated up to a maximum specified number of times (e.g., 10 times). Each cycle may reduce the gap between the training error and the testing error. After a number of cycles, the training and testing error may stop decreasing. In one implementation, the number of cycles to run before the errors stops improving may depend on the network. For a network with a good starting error, it may take about 4 cycles before it gets to its best performances. For some networks, it may take about 10 cycles to minimize the training and testing error. Such retraining may fine tune a network applying other training methods on a subset of the data set training (e.g., the training method used for one of steps 129, 151, 173 may differ from the training method used for another one of steps 129, 151, 173). The training may be a looping process in which the weights matrix for the input neurons may be adjusted to minimize the output error. A loop cycle may be called an epoch. The number of training epochs may be an input parameter and may be saved in the network definition (e.g., definition 234 of FIG. 2 described below). Each epoch may calculate a minimum local error, the global minimum error may define the network performances and may also be saved in the network definition (e.g., definition 235 of FIG. 2 described below). A neural network may be a C# class. The definition of this C# class may be saved in the data store (e.g., at definition 236 of FIG. 2 described below), from where it may be loaded and/or instantiated as a memory object during an estimation process. A neural network may be an object, such as an instantiation of a C# class that may be serialized and saved in the system data store. For example, if the selected neural network's performance is not acceptable after the specified number of cycles, the selected neural network may be discarded and another neural network may be selected for analysis (e.g., a new neural network, a neural network not originally selected at step 141). If the performance of a neural network is not acceptable and is discarded, the REP may be operative to obtain a new neural network from the group of best performing (e.g., from the group selected at step 141) or a progressive retrain may be started for an existing neural network that may have already been saved in the database or for a totally new neural network that may not have been generated during a bulk training session.

In some implementations, an overall performance level may be determined (e.g., as a percentage error) for the set of neural networks. For example, the overall performance level may be the average of individual errors produced by the neural networks in the set of neural networks. The overall performance may be evaluated by the REP based on the testing results (e.g., and not the training results). The system performances can vary with properties type (e.g., better for condos than for houses), can also vary by geographical location, set of characteristics, etc. Steps 153-177 may define a progressive retrain process or algorithm. Such a process may be applied by the REP for an individual neural network to improve its performances but may not be defined as a necessity. If a normal or initial training session of the REP creates a neural network with acceptable performances, the REP may not conduct a progressive retrain on that network. It is understood that the steps shown in process 100 of FIG. 1 are merely illustrative and that existing steps may be modified or omitted, additional steps may be added, and the order of certain steps may be altered.

FIG. 2 shows a block diagram illustrating an exemplary neural network training module diagram 200 in some embodiments of the REP. In FIG. 2, architecture 200 may include a library of training methods 210 that may be utilized to train neural networks (e.g., at one or more of steps 129, 161, and/or 173 of process 100). The library of training methods 210 or algorithms (e.g., learning algorithms) may include any suitable training methods including, but not limited to, Back Propagation 211, Resilient Propagation 212, Genetic Algorithms 213, Simulated Annealing 214, Levenberg 215, Nelder-Meade 216, and/or the like. Such training methods may be used individually and/or in different combinations to get the best performance from a neural network.

Neural network architecture 200 may include one or more data stores 220. In one embodiment, the data stores may include one or more network definitions 230 (e.g., as may be stored in the network definitions data store 830c described below). The network definitions may include any suitable data regarding a neural network including, but not limited to, the number of hidden layers 231, the number of neurons per hidden layer 232, the training method 233 used to train the neural network (e.g., at one or more of steps 129, 161, and/or 173 of process 100), the number of training epochs 234, the neural network's performance 235, a C# object 236 (e.g., binary, serialized, etc.) that may be used to load and instantiate a memory object representing the neural network, training strategies 237 (e.g., as may be applied during training of process 100 and/or 900), model type data 238 (e.g., feedforward, recurrent, etc.), and/or the like. Each neural network saved or otherwise available to the REP may include information about its architecture, training method and parameters and the body of the neural network, a serialized C# object, and the like. Each neural network may also include referential information or any suitable link between a main neural network and a retrained neural network.

In one embodiment, the data stores may include one or more data sets 240 (e.g., as may be stored in the data sets data store 830d described below). The data sets may include any suitable historical data records with any suitable data including, but not limited to, property characteristics 241, neighborhood characteristics 242, geographic localization 243, historical sales and renting transactions 244 (e.g., any suitable transactions data and/or time series of the predicted values (e.g., as may be provided by a recurrent neuronal network architecture, such as for a predicting neuronal network module, as described below, which may leverage different training methods than shown in library 210, such as back propagation through time (BPTT) (e.g., a training method that may be adapted from the feed forward networks), real-time recurrent learning (RTRL) (e.g., a gradient-descent method that may compute the exact error gradient at every time step), Extended Kalman filtering (EKF) (e.g., a state estimation technique for non-linear systems), etc., whereas network definitions 230 for a recurrent predicting model may alternatively or additionally include the number of memory steps, which may define the variation that the system may detect)), trends 245, economic data 246, and/or the like. Such data sets may be used for training and/or testing and may be structured in the REP system database based on layers. The data collection module of the REP may get information about unit characteristics, sales and renting transactions from multiple listing services, offline data files, public and government online services, buildings and house construction companies and may store it for use by the REP (e.g., as a system Building Spine repository). In some implementations, the data may be collected from online repositories containing closed sales and renting transactions. This type of data source may include transactional information like sale price, rent price, listing date, transaction date, and days on the market, but also information about the unit identification and characteristics. In some implementations, information about a building's or a unit's characteristics may be collected from online data services and saved on the system database. This information may be structured in the system. Building Spine may be leveraged as a multilayered repository. The first layer may contain information about the building characteristics like localization, year built, number of floors, etc. Each building may include an assigned set of addresses and a set of amenities and features. The system may assign a unique identifier BIN in a form of a numeric value. This value may be calculated by the system based on the building localization. The second layer may contain unit characteristics like sqft, number of bathrooms, number of bedrooms, unit floor, number of balconies, and their superficies. Each unit may be assigned a set of financial indicators like taxes, maintenance, and tax deductibility and a set of amenities and features exemplified in the table of amenities provided above, for example. A unique identifier may be assigned for each unit based on the unit apparent number and the building unique identifier BIN. The third layer may be built with information on transactions, sales, and/or rentals. Each unit may be assigned in this layer multiple records on the history of transactions for the last 20 years. This layer may have an auxiliary repository where the information about building and unit characteristics may be saved to the keep the history of all potential changes between transactions. For example, a unit sold in 2000 was declared as having 3 bedrooms and 1500 sqft, yet in 2005 this unit was registered again as a sales transaction but this time was mentioned to include only 2 bedrooms with the same value for sqft. There are 2 possible situations, a user data entry error occurred or the unit was transformed by merging 2 bedrooms. This discrepancy may be flagged by the system and if no automatic process is capable to fix this issue, a human operator intervention may be required. In some implementations, data may be imported from files with different data formatting. A module of the REP (e.g., a module that may be dedicated for offline file importing) may be operative to include a learning mechanism that may allow it to adapt to the data file structure based on the past experience. The module may scan a source folder for files to import. Each file may be loaded, scanned, and imported to the system data store. Each time a new data structure is identified by the system, the human operator may be asked to map the fields to the desired target fields and the system may store such a mapping. Next import, the system may analyze from memory all the combinations from past experience and all the files with a known structure may be unintendedly imported. The files with an unknown structure may be copied on a pending queue waiting for a manual fields mapping. In some implementation, data imported from the file system may be converted before being sent to the importing module. For example, a file conversion module may be operative to receive an Excel file formatted as .xls (e.g., a format prior to 2007) and to convert the file to .xlsx based on Open XML format. In some implementations, the list of amenities may be extracted from the unit description. The system may be operative to look for key words in the text description and the identified amenities may be saved in the system database. In some implementations, a combination logic may be applied in order to identify the proper amenity. For example, depending on the words identified, like “doorman” or “virtual doorman,” a building can be characterized as unattended, partially unattended, or fully attended.

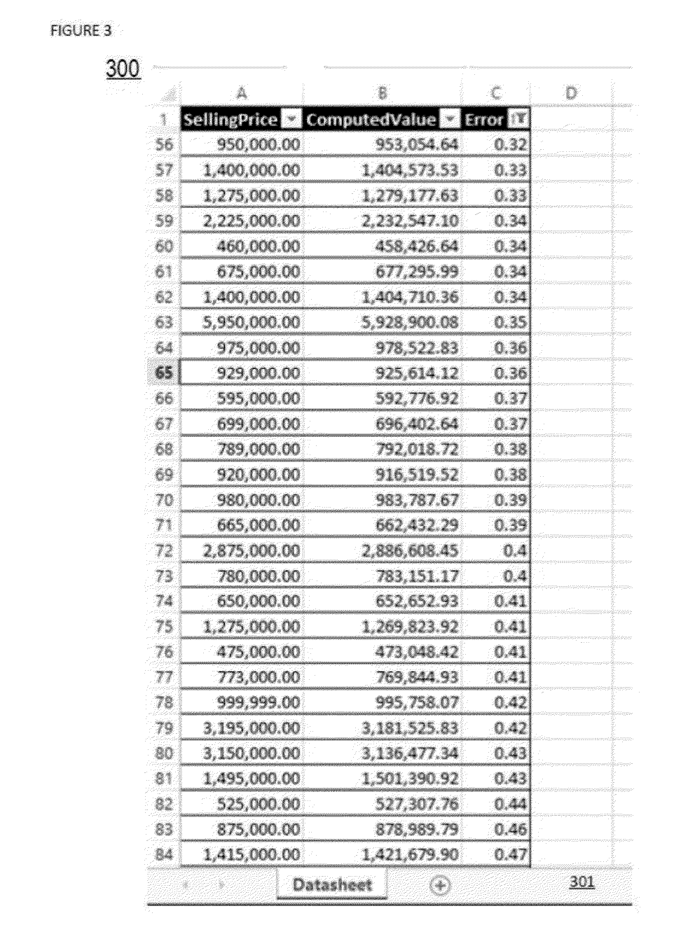

FIG. 3 shows a screen shot diagram 300 illustrating exemplary test results in accordance with some embodiments of the REP. In FIG. 3, a datasheet 301 of diagram 300 shows an example of at least a portion of test results for a neural network, where each row (e.g., each one of rows 56-84) may be associated with a particular neural network that has been tested (e.g., on multiple data records). The first column (e.g., column A) may show the reference value (e.g., actual selling price, such as 950,000.00 (e.g., real selling price of a recorded transaction)) of a record tested by a neural network, the second column (e.g., column B) may show the property value that may be estimated for that record by the neural network (e.g., 953,054.64), and the third column (e.g., column C) may show the error in the estimated value as a percentage (e.g., 0.32%).

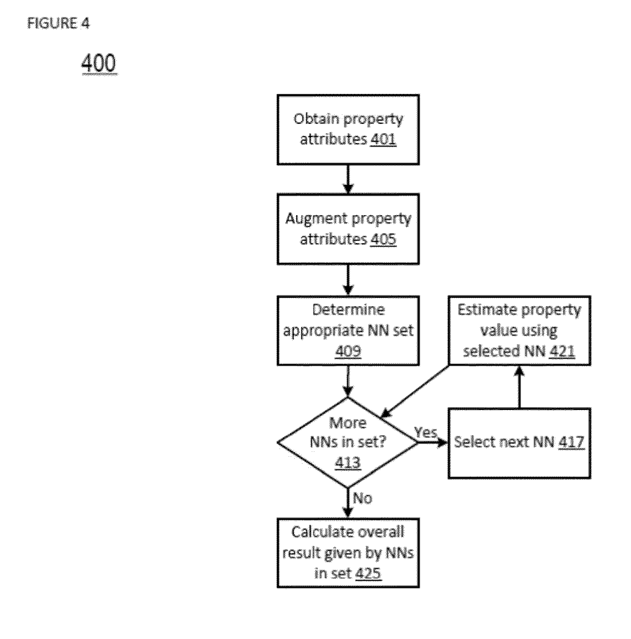

FIG. 4 shows a logic flow diagram illustrating a process 400 for estimating value (e.g., using a real estate value estimating (RVE) component) in accordance with some embodiments of the REP. FIG. 4 provides an example of how a set of neural networks may be used to estimate the value (e.g., property price, rental price, etc.) of a real estate property. In FIG. 4, attribute values of a property whose value should be estimated may be obtained at step 401 of process 400. In one embodiment, a user may utilize a website, a mobile app, an external application, and/or the like to specify any suitable attribute values for any suitable set of attributes. In one implementation, the user may specify attribute values for any of the attributes discussed with regard to step 105 of process 100. For example, the user may be enabled to enter attribute values for a minimum number of attributes (e.g., one or any other suitable number greater than one). In another example, the user may enter attribute values for a greater number of attributes to enhance the accuracy of the price prediction. The REP may be operative to enable a user to enter a minimum amount of information to allow the REP to identify a property (e.g., the address). The REP may be operative to load a list of characteristics from the database and automatically use them as inputs. If the REP is unable to find the property on the database, the REP may be operative to instruct the user to input as many characteristics as it can. The selection of the neural network by the REP to be used (e.g., for estimation) may be based on the number and the type of attributes entered by the user. This selection may be an automated process (e.g., the selection of neural network(s) for use may not be actively made by the user).

Attribute values for the property may be augmented at step 405 of process 400. In one implementation, default values (e.g., typical attribute values for similar properties) may be substituted for attribute values not provided by the user. In one embodiment, the user may enter attribute values for a property recognized (e.g., based on the address) by the REP (e.g., information regarding the property may be stored in the data sets data store 830d). Accordingly, the REP may retrieve such stored attribute value information and populate relevant fields (e.g., of any suitable GUI) with the retrieved attribute values. The user may accept a retrieved attribute value or may modify a retrieved attribute value (e.g., to reflect changes to the property). In one implementation, the user may be able to modify some attribute values (e.g., maintenance fee, which may change), but not other attribute values (e.g., year building was built, which may not change). For example, the GUI may be constructed to facilitate modification of those attribute values that may be modified (e.g., via input box widgets, dropdown widgets, and/or the like) and to disallow modification of those attribute values that may not be modified (e.g., by displaying such attribute values as non-editable text). In one implementation, if the user modifies an attribute value, the modified attribute value may replace the attribute value stored in the data store (e.g., after the information is verified, corrected, and/or approved by a REP administrator).

An appropriate set of neural networks to be used for estimating the value of the property may be determined at step 409 of process 400. In one embodiment, the appropriate set of neural networks may be determined based on attributes and/or attribute values and/or outputs desired for the property as may be provided by the user or otherwise. For example, the appropriate set of neural networks may be selected based on the unit type (e.g., one set of neural networks may be used to estimate the value of a condominium, another set of neural networks may be used to estimate the value of a commercial unit, and another set of neural networks may be used to estimate the value of a multi-unit building). In another example, the appropriate set of neural networks may be selected based on the type of value desired (e.g., one set of neural networks may be used to predict property prices, while another set of neural networks may be used to predict rental prices). The REP may include at least two different modules for rentals and sales. The user may be enabled o select the module it wants to use based on whether the user-requested process (e.g., estimate) is for a sales unit or a rental unit.

A determination may be made at step 413 of process 400 whether there are more neural networks in the selected set of neural networks. For example, each of the neural networks in the selected set of neural networks (e.g., as selected at step 409) may be utilized to estimate the value of the property. If there are no more neural networks to utilize, then process 400 may advance to step 425 described below. Otherwise, if there are any more neural networks to utilize, the next neural network may be selected at step 417 of process 400.

The value of the property may be estimated using the selected neural network of step 417 at step 421 of process 400. In one embodiment, one or more suitable attribute values for the property (e.g., as may be obtained at step 401 and/or augmented at step 405) may be provided as inputs to the input layer of the selected neural network, and the estimated property value may be obtained as output from the output layer of the selected neural network. In one implementation, attribute values may be converted into numerical values (e.g., using referential tables) and/or normalized prior to providing the attribute values to the selected neural network.

When there are no more neural networks to utilize (e.g., as determined at step 413), then the overall result given by the neural networks in the selected set of neural networks may be calculated at step 425 of process 400. For example, the overall result may be displayed to the user. In one embodiment, the overall estimated property value may be calculated as the average of estimated property values from each of the neural networks in the selected set of neural networks (e.g., an average of each property value estimated at step 421). In one implementation, the average may be weighted based on performance (e.g., an estimate from a neural network with a lower percentage error may be weighted higher than an estimate from a neural network with a higher percentage error (e.g., as may have been determined for that record at step 137). In another embodiment, the interval associated with the estimated property value may be calculated. In one implementation, the interval may be based on the overall performance level associated with the selected set of neural networks. For example, the minimum value of the interval may be calculated as the overall estimated property value reduced based on the error percentage associated with the set of neural networks, and the maximum value of the interval may be calculated as the overall estimated property value increased based on the error percentage associated with the set of neural networks (e.g., the percentage error may be the testing error determined at the end of process 100, and by using multiple neural networks for the same estimation, the performances of each neural network of the set may be averaged and percentage error may be applied to the average estimate). In another implementation, the smallest and the largest estimated property values calculated by the neural networks in the selected set of neural networks may be used as the minimum and the maximum values, respectively, of the interval. It is understood that the steps shown in process 400 of FIG. 4 are merely illustrative and that existing steps may be modified or omitted, additional steps may be added, and the order of certain steps may be altered.

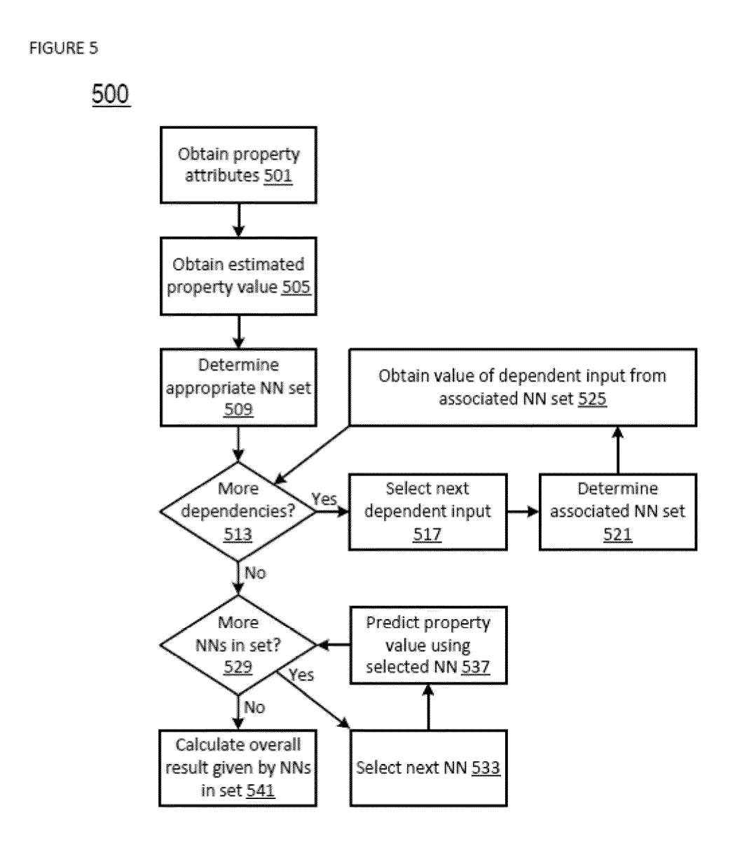

FIG. 5 shows a logic flow diagram illustrating a process 500 for predicting value (e.g., using a real estate value predicting (RVP) component) in accordance with some embodiments of the REP. FIG. 5 provides an example of how a set of neural networks may be used to predict values (e.g., predicted price in the future, other relevant data, such as direction of the market, number of days on the market, negotiation factor, and/or the like) for a real estate property. In one embodiment, a set of recurrent neural networks (e.g., Elman networks, Jordan networks, etc.) may be utilized to predict a value (e.g., based on dynamic time modeling). In one implementation, the set of neural networks to be used by process 500 may be generated in a similar manner as discussed with regard to process 100 of FIG. 1, but using different training methods, attribute sets, parameters, and/or the like. For example, the set of neural networks may be generated using training methods such as Back Propagation Through Time (BPTT), Real-Time Recurrent Learning (RTRL), Extended Kalman Filtering (EKF), and/or the like, each of which may also be available in training library 210 of FIG. 2). A neural network used for estimation may be based on a FeedForward model while a neural network used for prediction may be based on a recurrent neural network.

In FIG. 5, attribute values of a property for which a value should be predicted may be obtained at step 501 of process 500. In one embodiment, a user may utilize a website, a mobile app, an external application, and/or the like to specify attribute values for a set of attributes. In one implementation, the REP may obtain and/or augment attribute values at step 501 of process 500 of FIG. 5 as discussed with regard to steps 401 and 405 of process 400 of FIG. 4 (e.g., the user may wish to estimate the value of the property and to predict various values for the property). The data that may be entered by a user in the prediction module may be similar with the one for estimation. The user may not specify the date in time, as the REP may be operative to generate a prediction for one or more time frames determined by the REP to be as safe as possible, with a minimum or acceptable estimation error.

The estimated property value of the property may be obtained at step 505 of process 500. In one embodiment property value estimated as discussed with regard to FIG. 4 may be obtained. For example, if the property is a condominium, the estimated value of the condominium as determined by a set of neural networks used to estimate values of condominiums may be obtained. Accordingly, the output of one set of neural networks (e.g., used to estimate property value) may be used as an input to another set of neural networks (e.g., used to predict a value for the property) resulting in a cascading use of neural network sets.

An appropriate set of neural networks to be used for predicting the value for the property may be determined at 509. In one embodiment, the appropriate set of neural networks may be determined based on attributes and/or attribute values and/or outputs desired for the property provided by the user. For example, the appropriate set of neural networks may be selected based on the unit type (e.g., one set of neural networks may be used to predict the value for a condominium, another set of neural networks may be used to predict the value for a commercial unit, and another set of neural networks may be used to predict the value for a multi-unit building), for example, where neural networks for different property types may differ based on the set of attributes that may have been used to train the networks. In another embodiment, the appropriate set of neural networks may be determined based on the type of value desired (e.g., one set of neural networks may be used to predict the price in the future, while another set of neural networks may be used to predict the direction of the market). Based on the set of unit characteristics of attributes used for training a network may thus be specialized for one or more specific types of units. A neural network may be trained in a supervised process using as a baseline for output one of the unit characteristics, such as price or days on the market.

A determination may be made at step 513 of process 500 whether there are more dependencies to be selected for the set of neural networks selected at step 509 (e.g., other than the dependency on the estimated property value data obtained at step 505). For example, the output of a first set of neural networks (e.g., the output of a set of neural networks that may be used to predict direction of the market) may be used as an input to a second set of neural networks (e.g., the input to a set of neural networks that may be used to predict price of the property in the future) in a cascading manner. A neural network can use as input estimated results from another neural network. As mentioned, if a value like sqft is missing, then a neural network can be used to estimate that value. This may enable the REP to provide the concept of cascading multiple neural networks and using the estimated results of one neural network as input for another neural network. A neural network designed for prediction can use as inputs the results of one or more neural networks designed for estimation. Accordingly, an input of the second set of neural networks may have a dependency on the output of the first set of neural networks.

If there are more dependencies, the next dependent input may be selected at step 517 of process 500. The associated set of neural networks that predicts the value for the dependent input may be determined at step 521 of process 500, and the value of the dependent input may be obtained from the associated set of neural networks at step 525 of process 500.

If there are no more dependencies, a determination may be made at step 529 of process 500 whether there are more neural networks in the selected appropriate set of neural networks. For example, each of the neural networks in the selected appropriate set of neural networks (e.g., as determined at step 509) may be utilized to predict the value for the property. If there are more neural networks to utilize from that selected appropriate set for use in predicting such a value, the next neural network may be selected at step 533 of process 500.

The value for the property may be predicted using the selected neural network at step 537 of process 500. In one embodiment, attribute values for the property (e.g., as may be obtained and/or augmented at step 501) and/or dependent values (e.g., as may be obtained at one or more of step 505 and step 525) may be provided as inputs to the input layer of the selected neural network, and the predicted value for the property may be obtained as output from the output layer of the selected neural network. In one implementation, attribute values and/or dependent values may be converted into numerical values (e.g., using referential tables) and/or normalized prior to providing the attribute values and/or dependent values to the selected neural network.

In one implementation, the value predicted (e.g., at step 537) may be the predicted direction of the market. For example the REP may predict the trend of the pricing evolution for the property in the next X months based on inputs such as the estimated property value, trends data, and/or the like. In another implementation, the value predicted (e.g., at step 537) may be the predicted price of the property in the future. For example, the REP may predict the price of the property over the next X months based on inputs such as the estimated property value, the direction of the market, and/or the like. In yet another implementation, the value predicted (e.g., at step 537) may be the predicted expected number of days on the market for the property. For example, the REP may predict the expected number of days on the market for the property based on inputs such as listing price, season, and/or the like. In yet another implementation, the value predicted (e.g., at step 537) may be the predicted negotiation factor. For example, the REP may predict the listing price to be used to sell the property for a specified price in a specified period of time based on inputs such as transactions data, economic data, and/or the like. Using the historical information of the property type and location, the REP may be operative to predict the listing price of that property over the next x months. A group of recurrent neural networks may be trained on the historical data to find patterns in price variation over the time. The database may contain records of properties sold in last 20 years. This information may be prepared as a time series containing unit description and the price at which the unit was sold at a specific date (e.g., time series of the predicted values may be a data set in data sets 240 of FIG. 2). A neural network may be trained using as input parameters for each time unit “t” the real estate description and the sales price. The time unit “t” may be defined as month/year, so for each month a new set of parameters may be presented for training to the neural network input layer. To fill the gaps for the months where no price information is available for a unit type, an extrapolation process may be used by the REP that may calculate the missing values. Direction of the market may be enabled when the REP may be operative to create the trend of the pricing evolution for each type of property and/or neighborhood in the next x months. Based on the historical data, the REP may be operative to use a set of neural networks that can predict the price for the next “t+n” time units. A time unit may begin defined as a month. The REP may be operative to draw the price evolution for the next n months, where the n value may be defined as an internal system parameter and may be designed as the highest value for which the REP may generate a prediction with good accuracy. This analysis can be drilled down by unit type, neighborhood, unit properties like square feet, number of rooms, and the like. The amount of time the property is expected to stay on the market may be enabled for prediction when, in the REP, the historical information may include the number of days a property was on the market before being sold. Using a list of input parameters like listing price, unit type, season, and the like, a group of neural networks may be trained to recognize the variation on time of number of days on the market. These neural networks may be used to predict how many days a property is expected to stay on the market. Negotiation factor may be enabled as follows. The listing discount (e.g., any difference between the last listed price and the sale price) may be a barometer of the strength of the market. Based on historical information about the listing discount may predict the negotiation factor for a property (e.g., how to price the property to obtain the desired sale price). If the REP detects dependencies between the input and output parameters of sets of neural networks, multiple sets of neural networks may be cascaded to obtain the final result. For example, the REP may be requested to predict a property price and the REP may be operative to use an input parameter, such as the price increasing percentage. A set of neural networks may first be asked to predict the price increase and the result of this may be presented as input for the second set of neural networks. Data time frame optimization may be enabled by the REP. Prediction by the REP may be operative to use the historical data to find patterns in time and/or input space. During a training process, a neural network may be configured to take data samples from each time step and analyze the input parameters by comparing them with those from previous time steps. The set of input parameters for an “n” number of steps may be saved in the neural network memory so that it can be compared with the set for step “t”. When the neural network memory is full, the oldest input set may be erased to make place for the newest step. Such time shifting may take place over the entire length of data set. Using historical data with many years of data may give more chances to the neural network to recognize the pattern of price variation in time. Providing training data for the neural network with a lower unit for the time step (e.g., a month) may allow the network to detect rapid price variations in time. At the same time, the time frame of the historical data and a higher density of the time steps may utilize more time and resources allocated for the training process. The REP may be operative to find the right balance between the data set used and the neural network training results. An automated process may be operative to monitor the new data that may be imported to the REP and may be operative to create the proper data set for neural network training. A user, or any external system, can adjust information about a property. The information entered by the user for a specific property that is not in concordance with the existing information may be saved in a separate location in the database and presented for approval to the application administrator. If accepted, the property information may be updated and the process may be logged to keep the history of changes. An agent may periodically verify the changes rate (e.g., percentage of the number of records changed from the entire dataset) in the properties information used for the training. If this rate hits a certain level, a new process for network training may be started and a set of neuronal networks may then be updated. The system may be scheduled to execute periodical analysis. This analysis can reflect future price increasing for certain types of properties or can reveal trends in the real estate market. When these results are available, the system can notify its clients or can push the results to the registered clients. The two sets of neuronal networks (e.g., any RVE neural networks (e.g., as described with respect to process 400) that may be used for obtaining an estimated property value (e.g., at step 505), which may be feed forward networks for estimation; and any RVP neural networks for prediction (e.g., as used at steps 529-537), which may be recurrent networks for prediction) may be coupled through a collaboration module, which may make available output of one set of networks to the input of another. The data set used to train the two neural networks may have different structures. A feed forward neural network may utilize a training data set that may be rich on real estate property characteristics (e.g., data with a lot of information about the unit description, neighborhood, localization, amenities, etc., where such information may be as recent as possible and/or may be time delimited with no historical data). The data set that may be used to train a recurrent neural network may utilize historical data on information on price variation, days on the market, mortgage rates, consumer confidence indices, and other economic factors. When creating the time series of the price variation in time, when the price parameter is missing for a time unit, the REP may be operative to use a set of feed forward neural networks for price estimation and then may be operative to use such output with a set of recurrent neural networks for price prediction. Inside of each set of neural networks, the networks can be interconnected or intercoupled using a collaboration module. When an input parameter is missing for prediction, this parameter can be output by another neural network. To predict the number of days the unit will stay on the market, one of the input parameters may be the predicted price so that the output of a price prediction neural network may be used as input for the number of days on the market prediction neural network. An estimation module of a prediction system may be designed using a feed forward neural network that may be trained using back propagation techniques to distinguish between different real estate attributes. This pattern recognition may be an atemporal process that may be based on functions using a fixed input space. A prediction module of the system may be designed using a recurrent neural network to deal with dynamic time modeling. The recurrent neural network can reflect a system's dynamic character because it not only may operate on an input space but also on an internal state space, or trace of what already may have been processed by the network. For example, at least one neural network may be operative to estimate the actual price of a unit at a given time frame (e.g., current, 3 months ago, 6 months ago, etc.), where that neural network may be any suitable feed forward neural network (e.g., the network used at step 505 and/or determined and utilized at one or more iterations of steps 513-525), and where the estimated value that may be provided as an output of such a feed forward neural network may be provided as an input to a predicting recurrent neural network (e.g., as an input to the neural network used at one or more iterations of steps 533-537). The concept of a prediction module may be based on the theory of recurrent neural networks. A strict feed forward architecture may not maintain a short-term memory, where any memory effects may be due to the way past inputs are re-presented to the network. While a recurrent neural network may have activation feedback that may embody short-term memory. A state layer may be updated not only with the external input of the network but also with activation from the previous forward propagation. The context neurons of a recurrent neural network may receive a copy of hidden neurons of the network. There may exist, therefore, as many context neurons as hidden neurons in the network. The training mechanism for this network can be summarized as follows: (1). the activations of the context neurons may be initialized as zero at the initial instant; (2). the external input (x(t) . . . , x(t−d)) at instant t and the neurons context activations at instant t may be concatenated to determine the input vector u(t) to the network, which may be propagated towards the output of the network, that may obtain therefore the prediction at instant t+1; (3). the back propagation algorithm may be applied to modify the weights of the network; and (4). the time variable time may be increased in one unit and the procedure may go to element (2). The system may be using as input the historical data with time dependencies having as output a value that may appear randomly in the sequence. However, when the value appears, the REP may know that it may appear repeatedly for a number of times. If the time unit is considered as a month and the output value is the price variation indicator, in a normal financial context, the value may remain the same for a few time units. The error calculation of training a recurrent network may take into consideration that the local gradients may depend upon the time index. One common error criterion for dynamic neuronal networks may be trajectory learning where the cost may be summed over time from an initial time n=0 until the final time n=T. The errors can be back propagated further in time, where this process may be called back propagation through time (BPTT). The basic principle of BPTT is that of “unfolding.” The recurrent weights can be duplicated spatially for an arbitrary number of time steps. Consequently, each node that sends activation (e.g., either directly or indirectly) along a recurrent connection may have the same number of copies as the number of time steps. The number of steps in time (e.g., the memory length) may be experimentally determined. In practice, a large number of steps may be undesirable due to a “vanishing gradient effect”. For each layer the error may be back propagated though the error may get smaller and smaller until it may diminish (e.g., completely). For example, a first estimating neural network may be specially designed (e.g., trained and tested) for providing an estimated value of a property from 3 months ago (e.g., an estimated value of the property within the time frame between 3 and 6 months ago) and a second estimating neural network may be specially designed (e.g., trained and tested) for providing an estimated value of a property from 6 months ago (e.g., an estimated value of the property within the time frame between 6 and 9 months ago) and a third estimating neural network may be specially designed (e.g., trained and tested) for providing an estimated value of a property from 9 months ago (e.g., an estimated value of the property within the time frame between 9 and 12 months ago), and the output of each of such three estimating neural networks may be provided as a particular input to a predicting neural network that may provide a prediction of a value of a property in the future (e.g., 3 months from now).

The overall result given by the neural networks in the selected set of neural networks may be calculated at step 541 of process 500. For example, the overall result may be displayed to the user. In one embodiment, the overall predicted value for the property may be calculated as the average of predicted values for the property from each of the neural networks in the selected appropriate set of neural networks (e.g., an average of the values predicted by each iteration of step 537 for each neural network of the set determined at step 509). In one implementation, the average may be weighted based on performance (e.g., a prediction from a neural network with a lower percentage error may be weighted higher than a prediction from a neural network with a higher percentage error). In another embodiment, the interval associated with the predicted value for the property may be calculated. In one implementation, the interval may be based on the overall performance level associated with the selected appropriate set of neural networks. For example, the minimum value of the interval may be calculated as the overall predicted value for the property reduced based on the error percentage associated with the set of neural networks, and the maximum value of the interval may be calculated as the overall predicted value for the property increased based on the error percentage associated with the set of neural networks. In another implementation, the smallest and the largest predicted values for the property calculated by the neural networks in the selected appropriate set of neural networks may be used as the minimum and the maximum values, respectively, of the interval. It is understood that the steps shown in process 500 of FIG. 5 are merely illustrative and that existing steps may be modified or omitted, additional steps may be added, and the order of certain steps may be altered.

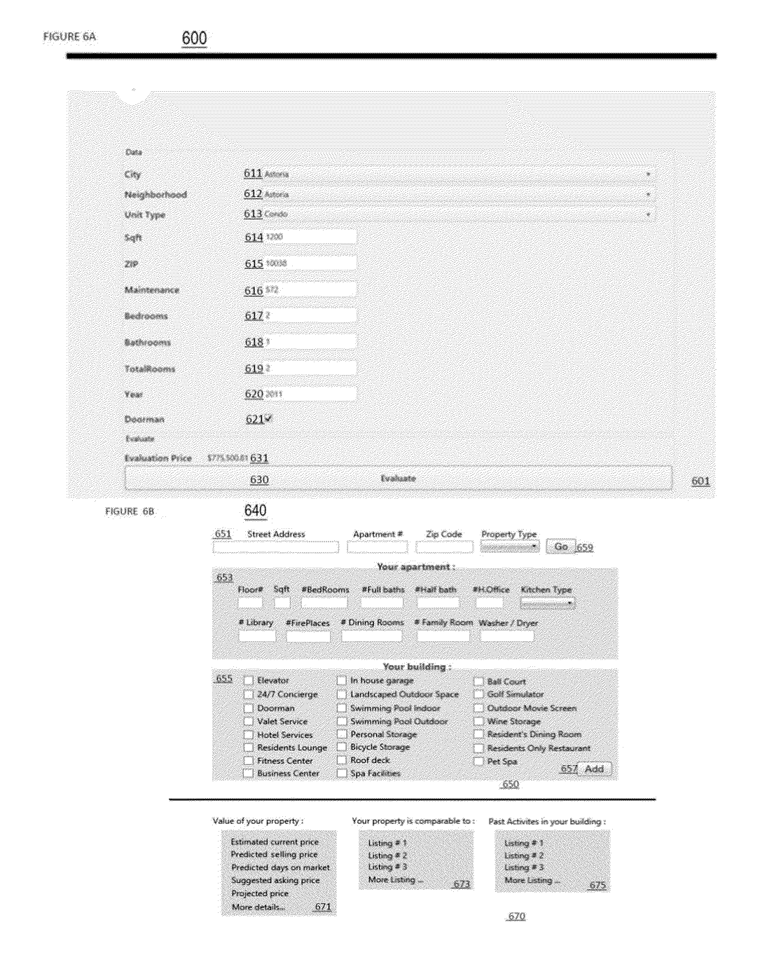

FIG. 6A shows a screen shot diagram 600 illustrating an exemplary user interface in one embodiment of the REP. FIG. 6A provides an example of the GUI 601 that may be utilized by a user to obtain an estimate of the value of a property. In FIG. 6A, a set of neural networks used for estimating the value of the property may be selected. In one embodiment, the set of neural networks may be selected based on attributes and/or attribute values for the property as may be provided by the user at GUI 601.

The user may specify various attribute values for the property such as city at an attribute entry field 611 (e.g., Astoria), neighborhood at an attribute entry field 612 (e.g., Astoria), unit type at an attribute entry field 613 (e.g., condominium), square footage at an attribute entry field 614 (e.g., 1,200 square feet), zip code at an attribute entry field 615 (e.g., 10038), maintenance fee at an attribute entry field 616 (e.g., $572 per month), number of bedrooms at an attribute entry field 617 (e.g., 2 bedrooms), number of bathrooms at an attribute entry field 618 (e.g., 1 bathroom), total number of rooms at an attribute entry field 619 (e.g., 2 total rooms), year when the property was built at an attribute entry field 620 (e.g., 2011), whether there is a doorman at an attribute entry field 621 (e.g., there is a doorman), and/or the like. In some implementations, attributes for which the user may specify values (e.g., attributes for which attribute fields appear in the GUI) may depend on attribute values of other attributes. For example, if the user sets the unit type at attribute entry field 613 to be condominium, attributes at attribute entry fields 614 through 621 that are associated with condominiums may be shown in the GUI.

The user may click on the “Evaluate” GUI widget 630 to obtain the estimated value of the property at a results field 631 (e.g., property price of $775,500.81). For example, the selected set of neural networks (e.g., previously trained as discussed with regard to process 100 of FIG. 1) may be used to estimate (e.g., as discussed with regard to process 400 of FIG. 4) the value of the property (e.g., substantially instantaneously, such as within seconds).

FIG. 6B shows a screen shot diagram 640 illustrating an exemplary user interface in one embodiment of the REP. FIG. 6B provides another example of a GUI that may be utilized by a user to obtain estimated and/or predicted values for a property. In FIG. 6B screen 650 shows how the user may select attributes and/or specify attribute values for the property.

In one embodiment, the user may utilize section 651 to specify geographic information (e.g., street address, apartment number, zip code, etc.) and/or property type for the property. In one implementation, if the property is recognized (e.g., based on the geographic information) by the REP, the REP may retrieve stored attribute value information (e.g., as may be stored in the data sets data store 830d) and may populate relevant GUI widgets of sections 653 and/or 655 based on the retrieved attribute values. The user may utilize section 653 to specify and/or modify attribute values regarding the apartment (e.g., floor number, square feet, number of bedrooms, number of full baths, number of half baths, number of offices, kitchen type, number of libraries, number of fire places, number of dining rooms, number of family rooms, number of washers and dryers, etc.). The user may utilize section 655 to specify and/or modify attribute values regarding the building (e.g., elevator, garage, doorman, etc.). In some implementations, the GUI may display a subset of attributes (e.g., building amenities) that may be available (e.g., the most common amenities available for the specified property type). Accordingly, the user may utilize the “Add” GUI widget 657 to display a screen that facilitates adding additional attributes. The user may utilize the “Go” GUI widget 659 to instruct the REP to determine estimated and/or predicted values for the property.

In one embodiment, the user may utilize screen 670 to view the estimated and/or predicted values for the property. The user may utilize section 671 to view values for the property, such as estimated current price, predicted selling price, predicted days on the market, suggested asking price, projected price, and/or the like. The user may utilize section 673 to view comparable properties for the property. In one implementation, an explanation of any change in predicted value (e.g., predicted by a set of neural networks) of a comparable property relative to the time of transaction may be provided (e.g., the comparable property sold for $X two years ago, during this time the market rose Y %). The user may utilize section 675 to view past activities in the building.

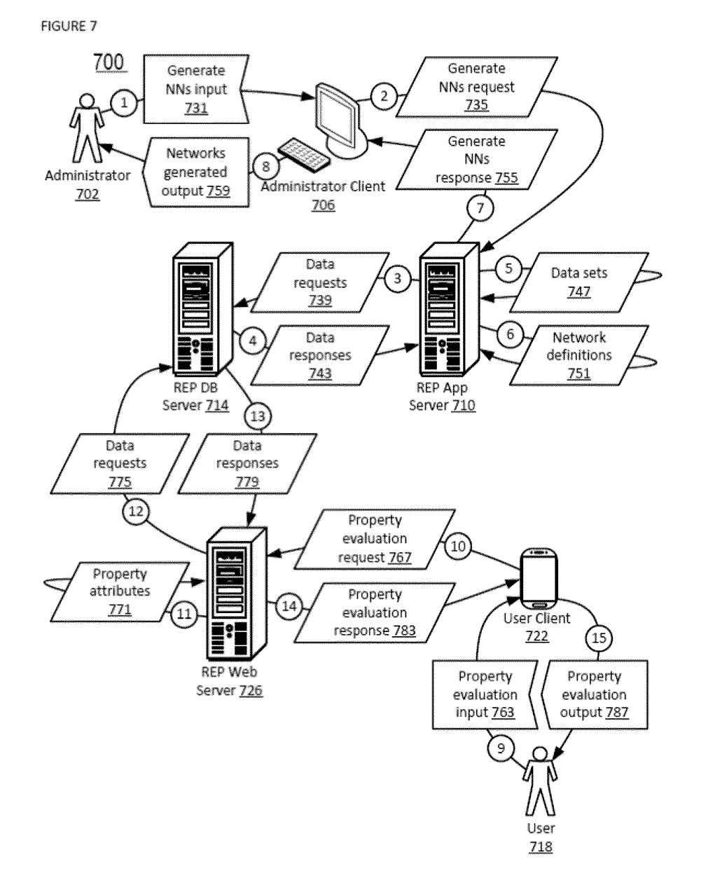

FIG. 7 shows a data flow diagram 700 in one embodiment of the REP. FIG. 7 provides an example of how data may flow to, through, and/or from the REP. In FIG. 7, an REP administrator 702 may input instructions 731 (e.g., at a step 1) to an administrator client 706 (e.g., a desktop, a laptop, a tablet, a smartphone, etc.) to generate a set of neural networks. In one implementation, the administrator may utilize a peripheral device (e.g., a keyboard, a mouse, a touchscreen, etc.) of the administrator client to provide such instructions. For example, the administrator's instructions may include parameters such as a unit type selection, an attribute set selection, training data set parameters, testing data set parameters, training method parameters, neural network parameters, and/or the like.

The administrator client may send a generate neural networks request 735 (e.g., at a step 2) to a REP App Server 710. In one implementation, the REP App Server may generate the set of neural networks. For example, the generate neural networks request may include data such as the administrator's login credentials, the date and/or time of the request, parameters specified by the administrator, and/or the like.

The REP App Server may send data requests 739 (e.g., at a step 3) to a REP DB Server 714. In one implementation, the REP DB Server may host data stores (e.g., data stores 830) utilized by the REP. For example, the data requests may prompt the REP DB Server to provide data, such as data sets, network definitions, and/or the like. The REP DB Server may provide such data via data responses 743 (e.g., at a step 4).

The App Server may utilize data sets 747 (e.g., data sets 240) (e.g., at a step 5) and/or network definitions 751 (e.g., network definitions 230) (e.g., at a step 6) to generate the set of neural networks. The generated set of neural networks may be stored on the REP DB Server (e.g., via additional data requests).

The App Server may send a generate neural networks response 755 (e.g., at a step 7) to the administrator client. For example, the generate neural networks response may include information such as a confirmation that the set of neural networks was generated, an error code, and/or the like. The administrator client may output such information 759 (e.g., at a step 8) to the administrator (e.g., display such information on the screen, provide an audio alert, etc.).

A user 718 may provide instructions 763 (e.g., at a step 9) to evaluate (e.g., estimate value, predict value, etc.) a property to a user client 722 (e.g., a desktop, a laptop, a tablet, a smartphone, etc.). In one implementation, the user may utilize a website to input instructions. In another implementation, the user may utilize a mobile app to input instructions. In yet another implementation, the user may utilize an external application (e.g., that utilizes an API to communicate with the REP) to input instructions. For example, the user's instructions may include parameters such as attribute values, outputs desired (e.g., property price, rental price, future pricing, direction of the market, expected days on the market, negotiation factor, comparables, etc.), and/or the like.

The user client may send a property evaluation request 767 (e.g., at a step 10) to a REP Web Server 726. In one implementation, the REP Web Server may determine outputs desired by the user. For example, the property evaluation request may include data such as the user's login credentials, the date and/or time of the request, parameters specified by the user, and/or the like.

The REP Web Server may analyze property attributes 771 (e.g., attributes, attribute values, etc.) (e.g., at a step 11) to determine the appropriate set of neural networks to use to estimate property value and/or to predict other outputs. The REP Web Server may send data request 775 (e.g., at a step 12) to the REP DB Server to retrieve data, such as data sets, network definitions, and/or the like. The REP DB Server may provide such data via data responses 779 (e.g., at a step 13).

The REP Web Server may send a property evaluation response 783 (e.g., at a step 14) to the user client. For example, the property evaluation response may include information such as the outputs desired by the user, an error code, and/or the like. The user client may output such information 787 (e.g., at a step 15) to the user (e.g., display such information on the screen, provide an audio alert, etc.). It is understood that the steps shown in flow diagram 700 of FIG. 7 are merely illustrative and that existing steps may be modified or omitted, additional steps may be added, and the order of certain steps may be altered.

### DETAILED DESCRIPTION OF THE REP COORDINATOR

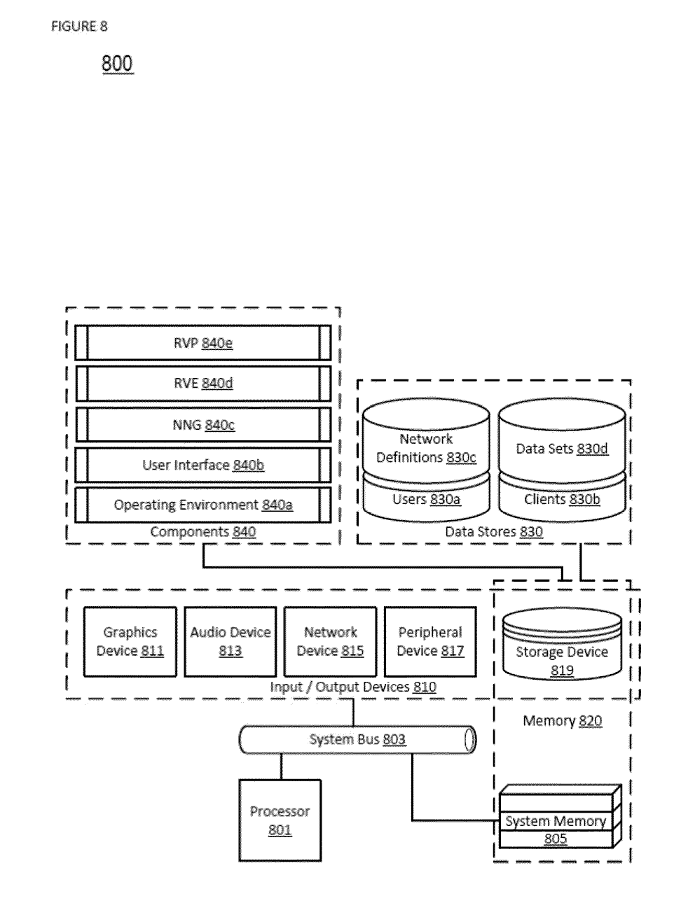

FIG. 8 shows a block diagram illustrating an exemplary REP coordinator 800 in one embodiment of the REP. The REP coordinator facilitates the operation of the REP via a computer system (e.g., one or more cloud computing systems, grid computing systems, virtualized computer systems, mainframe computers, servers, clients, nodes, desktops, mobile devices such as smart phones, cellular phones, tablets, personal digital assistants (PDAs), and/or the like, embedded computers, dedicated computers, a system on a chip (SOC)). For example, the REP coordinator may receive, obtain, aggregate, process, generate, store, retrieve, send, delete, input, output, and/or the like data (including program data and program instructions); may execute program instructions; may communicate with computer systems, with nodes, with users, and/or the like. In various embodiments, the REP coordinator may include a standalone computer system, a distributed computer system, a node in a computer network (i.e., a network of computer systems organized in a topology), a network of REP coordinators, and/or the like. It is to be understood that the REP coordinator and/or the various REP coordinator elements (e.g., processor, system bus, memory, input/output devices) may be organized in any number of ways (i.e., using any number and configuration of computer systems, computer networks, nodes, REP coordinator elements, and/or the like) to facilitate REP operation. Furthermore, it is to be understood that the various REP coordinator computer systems, REP coordinator computer networks, REP coordinator nodes, REP coordinator elements, and/or the like may communicate among each other in any number of ways to facilitate REP operation. As used in this disclosure, the term “user” may refer generally to people and/or computer systems that may interact with the REP; the term “server” may refer generally to a computer system, a program, and/or a combination thereof that may handle requests and/or respond to requests from clients via a computer network; the term “client” may refer generally to a computer system, a program, a user, and/or a combination thereof that may generate requests and/or handle responses from servers via a computer network; the term “node” may refer generally to a server, to a client, and/or to an intermediary computer system, program, and/or a combination thereof that may facilitate transmission of and/or handling of requests and/or responses.

The REP coordinator may include a processor 801 that may execute program instructions (e.g., REP program instructions). In various embodiments, the processor may be a general purpose microprocessor (e.g., a central processing unit (CPU)), a dedicated microprocessor (e.g., a graphics processing unit (GPU), a physics processing unit (PPU), a digital signal processor (DSP), a network processor, and/or the like), an external processor, a plurality of processors (e.g., working in parallel, distributed, and/or the like), a microcontroller (e.g., for an embedded system), and/or the like. The processor may be implemented using integrated circuits (ICs), application-specific integrated circuits (ASICs), field-programmable gate arrays (FPGAs), and/or the like. In various implementations, the processor may include one or more cores, may include embedded elements (e.g., a coprocessor such as a math coprocessor, a cryptographic coprocessor, a physics coprocessor, and/or the like, registers, cache memory, software), may be synchronous (e.g., using a clock signal) or asynchronous (e.g., without a central clock), and/or the like. For example, the processor may be an AMD FX processor, an AMD Opteron processor, an AMD Geode LX processor, an Intel Core i7 processor, an Intel Xeon processor, an Intel Atom processor, an ARM Cortex processor, an IBM PowerPC processor, and/or the like.

The processor may be coupled to system memory 805 via a system bus 803. The system bus may intercouple or interconnect these and/or other elements of the REP coordinator via electrical, electronic, optical, wireless, and/or the like communication links (e.g., the system bus may be integrated into a motherboard that may intercouple or interconnect REP coordinator elements and provide power from a power supply). In various embodiments, the system bus may include one or more control buses, address buses, data buses, memory buses, peripheral buses, and/or the like. In various implementations, the system bus may be a parallel bus, a serial bus, a daisy chain design, a hub design, and/or the like. For example, the system bus may include a front-side bus, a back-side bus, AMD's HyperTransport, Intel's QuickPath Interconnect, a peripheral component interconnect (PCI) bus, an accelerated graphics port (AGP) bus, a PCI Express bus, a low pin count (LPC) bus, a universal serial bus (USB), and/or the like. The system memory, in various embodiments, may include registers, cache memory (e.g., level one, level two, level three), read only memory (ROM) (e.g., BIOS, flash memory), random access memory (RAM) (e.g., static RAM (SRAM), dynamic RAM (DRAM), error-correcting code (ECC) memory), and/or the like. The system memory may be discreet, external, embedded, integrated into a CPU, and/or the like. The processor may access, read from, write to, store in, erase, modify, and/or the like, the system memory in accordance with program instructions (e.g., REP program instructions) executed by the processor. The system memory may facilitate accessing, storing, retrieving, modifying, deleting, and/or the like data (e.g., REP data) by the processor.

In various embodiments, input/output devices 810 may be coupled to the processor and/or to the system memory, and/or to one another via the system bus.

In some embodiments, the input/output devices may include one or more graphics devices 811. The processor may make use of the one or more graphic devices in accordance with program instructions (e.g., REP program instructions) executed by the processor. In one implementation, a graphics device may be a video card that may obtain (e.g., via a coupled video camera), process (e.g., render a frame), output (e.g., via a coupled monitor, television, and/or the like), and/or the like graphical (e.g., multimedia, video, image, text) data (e.g., REP data). A video card may be coupled to the system bus via an interface such as PCI, AGP, PCI Express, USB, PC Card, ExpressCard, and/or the like. A video card may use one or more graphics processing units (GPUs), for example, by utilizing AMD's CrossFireX and/or NVIDIA's SLI technologies. A video card may be coupled via an interface (e.g., video graphics array (VGA), digital video interface (DVI), Mini-DVI, Micro-DVI, high-definition multimedia interface (HDMI), DisplayPort, Thunderbolt, composite video, S-Video, component video, and/or the like) to one or more displays (e.g., cathode ray tube (CRT), liquid crystal display (LCD), touchscreen, and/or the like) that display graphics. For example, a video card may be an AMD Radeon HD 6990, an ATI Mobility Radeon HD 5870, an AMD FirePro V9800P, an AMD Radeon E6760 MXM V3.0 Module, an NVIDIA GeForce GTX 590, an NVIDIA GeForce GTX 580M, an Intel HD Graphics 3000, and/or the like. In another implementation, a graphics device may be a video capture board that may obtain (e.g., via coaxial cable), process (e.g., overlay with other graphical data), capture, convert (e.g., between different formats, such as MPEG2 to H.264), and/or the like graphical data. A video capture board may be and/or include a TV tuner, may be compatible with a variety of broadcast signals (e.g., NTSC, PAL, ATSC, QAM) may be a part of a video card, and/or the like. For example, a video capture board may be an ATI All-in-Wonder HD, a Hauppauge ImpactVBR 01381, a Hauppauge WinTV-HVR-2250, a Hauppauge Colossus 01414, and/or the like. A graphics device may be discreet, external, embedded, integrated into a CPU, and/or the like. A graphics device may operate in combination with other graphics devices (e.g., in parallel) to provide improved capabilities, data throughput, color depth, and/or the like.

In some embodiments, the input/output devices may include one or more audio devices 813. The processor may make use of the one or more audio devices in accordance with program instructions (e.g., REP program instructions) executed by the processor. In one implementation, an audio device may be a sound card that may obtain (e.g., via a coupled microphone), process, output (e.g., via coupled speakers), and/or the like audio data (e.g., REP data). A sound card may be coupled to the system bus via an interface such as PCI, PCI Express, USB, PC Card, ExpressCard, and/or the like. A sound card may be coupled via an interface (e.g., tip sleeve (TS), tip ring sleeve (TRS), RCA, TOSLINK, optical) to one or more amplifiers, speakers (e.g., mono, stereo, surround sound), subwoofers, digital musical instruments, and/or the like. For example, a sound card may be an Intel AC′97 integrated codec chip, an Intel HD Audio integrated codec chip, a Creative Sound Blaster X-Fi Titanium HD, a Creative Sound Blaster X-Fi Go! Pro, a Creative Sound Blaster Recon 3D, a Turtle Beach Riviera, a Turtle Beach Amigo II, and/or the like. An audio device may be discreet, external, embedded, integrated into a motherboard, and/or the like. An audio device may operate in combination with other audio devices (e.g., in parallel) to provide improved capabilities, data throughput, audio quality, and/or the like.

In some embodiments, the input/output devices may include one or more network devices 815. The processor may make use of the one or more network devices in accordance with program instructions (e.g., REP program instructions) executed by the processor. In one implementation, a network device may be a network card that may obtain (e.g., via a Category 5 Ethernet cable), process, output (e.g., via a wireless antenna), and/or the like network data (e.g., REP data). A network card may be coupled to the system bus via an interface such as PCI, PCI Express, USB, FireWire, PC Card, ExpressCard, and/or the like. A network card may be a wired network card (e.g., 10/100/1000, optical fiber), a wireless network card (e.g., Wi-Fi 802.11a/b/g/n/ac/ad, Bluetooth, Near Field Communication (NFC), TransferJet), a modem (e.g., dialup telephone-based, asymmetric digital subscriber line (ADSL), cable modem, power line modem, wireless modem based on cellular protocols such as high speed packet access (HSPA), evolution-data optimized (EV-DO), global system for mobile communications (GSM), worldwide interoperability for microwave access (WiMax), long term evolution (LTE), and/or the like, satellite modern, FM radio modem, radio-frequency identification (RFID) modem, infrared (IR) modern), and/or the like. For example, a network card may be an Intel EXPI9301CT, an Intel EXPI9402PT, a LINKSYS USB300M, a BUFFALO WLI-UC-G450, a Rosewill RNX-MiniN1, a TRENDnet TEW-623PI, a Rosewill RNX-N180UBE, an ASUS USB-BT211, a MOTOROLA SB6120, a U.S. Robotics USR5686G, a Zoom 5697-00-00F, a TRENDnet TPL-401E2K, a D-Link DHP-W306AV, a StarTech ET91000SC, a Broadcom BCM20791, a Broadcom InConcert BCM4330, a Broadcom BCM4360, an LG VL600, a Qualcomm MDM9600, a Toshiba TC35420 TransferJet device, and/or the like. A network device may be discreet, external, embedded, integrated into a motherboard, and/or the like. A network device may operate in combination with other network devices (e.g., in parallel) to provide improved data throughput, redundancy, and/or the like. For example, protocols such as link aggregation control protocol (LACP) based on IEEE 802.3AD-2000 or IEEE 802.1AX-2008 standards may be used. A network device may be used to couple to a local area network (LAN), a wide area network (WAN), a metropolitan area network (MAN), a personal area network, the Internet, an intranet, a Bluetooth network, an NFC network, a Wi-Fi network, a cellular network, and/or the like.

In some embodiments, the input/output devices may include one or more peripheral devices 817. The processor may make use of the one or more peripheral devices in accordance with program instructions (e.g., REP program instructions) executed by the processor. In various implementations, a peripheral device may be a digital camera, a video camera, a webcam, an electronically moveable pan tilt zoom (PTZ) camera, a monitor, a touchscreen display, active shutter 3D glasses, head-tracking 3D glasses, a remote control, an audio line-in, an audio line-out, a microphone, headphones, speakers, a subwoofer, a router, a hub, a switch, a firewall, an antenna, a keyboard, a mouse, a trackpad, a trackball, a digitizing tablet, a stylus, a joystick, a gamepad, a game controller, a force-feedback device, a laser, sensors (e.g., proximity sensor, rangefinder, ambient temperature sensor, ambient light sensor, humidity sensor, an accelerometer, a gyroscope, a motion sensor, an olfaction sensor, a biosensor, a chemical sensor, a magnetometer, a radar, a sonar, a location sensor such as global positioning system (GPS), Galileo, GLONASS, and/or the like), a printer, a fax, a scanner, a copier, a card reader, and/or the like. A peripheral device may be coupled to the system bus via an interface such as PCI, PCI Express, USB, FireWire, VGA, DVI, Mini-DVI, Micro-DVI, HDMI, DisplayPort, Thunderbolt, composite video, S-Video, component video, PC Card, ExpressCard, serial port, parallel port, PS/2, TS, TRS, RCA, TOSLINK, network connection (e.g., wired such as Ethernet, optical fiber, and/or the like, wireless such as Wi-Fi, Bluetooth, NFC, cellular, and/or the like), a connector of another input/output device, and/or the like. A peripheral device may be discreet, external, embedded, integrated (e.g., into a processor, into a motherboard), and/or the like. A peripheral device may operate in combination with other peripheral devices (e.g., in parallel) to provide the REP coordinator with a variety of input, output and processing capabilities.

In some embodiments, the input/output devices may include one or more storage devices 819. The processor may access, read from, write to, store in, erase, modify, and/or the like a storage device in accordance with program instructions (e.g., REP program instructions) executed by the processor. A storage device may facilitate accessing, storing, retrieving, modifying, deleting, and/or the like data (e.g., REP data) by the processor. In one implementation, the processor may access data from the storage device directly via the system bus. In another implementation, the processor may access data from the storage device by instructing the storage device to transfer the data to the system memory and accessing the data from the system memory. In various embodiments, a storage device may be a hard disk drive (HDD), a solid-state drive (SSD), a floppy drive using diskettes, an optical disk drive (e.g., compact disk (CD-ROM) drive, CD-Recordable (CD-R) drive, CD-Rewriteable (CD-RW) drive, digital versatile disc (DVD-ROM) drive, DVD-R drive, DVD-RW drive, Blu-ray disk (BD) drive) using an optical medium, a magnetic tape drive using a magnetic tape, a memory card (e.g., a USB flash drive, a compact flash (CF) card, a secure digital extended capacity (SDXC) card), a network attached storage (NAS), a direct-attached storage (DAS), a storage area network (SAN), other processor-readable physical mediums, and/or the like. A storage device may be coupled to the system bus via an interface such as PCI, PCI Express, USB, FireWire, PC Card, ExpressCard, integrated drive electronics (IDE), serial advanced technology attachment (SATA), external SATA (eSATA), small computer system interface (SCSI), serial attached SCSI (SAS), fibre channel (FC), network connection (e.g., wired such as Ethernet, optical fiber, and/or the like; wireless such as Wi-Fi, Bluetooth, NFC, cellular, and/or the like), and/or the like. A storage device may be discreet, external, embedded, integrated (e.g., into a motherboard, into another storage device), and/or the like. A storage device may operate in combination with other storage devices to provide improved capacity, data throughput, data redundancy, and/or the like. For example, protocols such as redundant array of independent disks (RAID) (e.g., RAID 0 (striping), RAID 1 (mirroring), RAID 5 (striping with distributed parity), hybrid RAID), just a bunch of drives (MOD), and/or the like may be used. In another example, virtual and/or physical drives may be pooled to create a storage pool. In yet another example, an SSD cache may be used with a HDD to improve speed.

Together and/or separately the system memory 805 and the one or more storage devices 819 may be referred to as memory 820 (i.e., physical memory).

REP memory 820 may contain processor-operable (e.g., accessible) REP data stores 830. Data stores 830 may include data that may be used (e.g., by the REP) via the REP coordinator. Such data may be organized using one or more data formats such as a database (e.g., a relational database with database tables, an object-oriented database, a graph database, a hierarchical database), a flat file (e.g., organized into a tabular format), a binary file (e.g., a GIF file, an MPEG-4 file), a structured file (e.g., an HTML file, an XML file), a text file, and/or the like. Furthermore, data may be organized using one or more data structures such as an array, a queue, a stack, a set, a linked list, a map, a tree, a hash, a record, an object, a directed graph, and/or the like. In various embodiments, data stores may be organized in any number of ways (i.e., using any number and configuration of data formats, data structures, REP coordinator elements, and/or the like) to facilitate REP operation. For example, REP data stores may include data stores 830a-d that may be implemented as one or more databases. A users data store 830a may be a collection of database tables that include fields such as UserID. UserName. UserPreferences, and/or the like. A clients data store 830b may be a collection of database tables that include fields such as ClientID, ClientName, ClientDeviceType, ClientScreenResolution, and/or the like. A network definitions data store 830c may be a collection of database tables that include fields such as NeuralNetworkID, NumberHiddenLayers, NumberNeuronsPerLayer, TrainingMethod, TrainingEpochs, Performance, BinaryClass, and/or the like. A data sets data store 830d may be a collection of database tables that include fields such as PropertyID, PropertyAttributes, PropertyAttributeValues, and/or the like. The REP coordinator may use data stores 830 to keep track of inputs, parameters, settings, variables, records, outputs, and/or the like.

REP memory 820 may contain processor-operable (e.g., executable) REP components 840. Components 840 may include program components (including program instructions and any associated data stores) that may be executed (e.g., by the REP) via the REP coordinator (i.e., via the processor) to transform REP inputs into REP outputs. It is to be understood that the various components and their subcomponents, capabilities, applications, and/or the like may be organized in any number of ways (i.e., using any number and configuration of components, subcomponents, capabilities, applications, REP coordinator elements, and/or the like) to facilitate REP operation. Furthermore, it is to be understood that the various components and their subcomponents, capabilities, applications, and/or the like may communicate among each other in any number of ways to facilitate REP operation. For example, the various components and their subcomponents, capabilities, applications, and/or the like may be combined, integrated, consolidated, split up, distributed, and/or the like in any number of ways to facilitate REP operation. In another example, a single or multiple instances of the various components and their subcomponents, capabilities, applications, and/or the like may be instantiated on each of a single REP coordinator node, across multiple REP coordinator nodes, and/or the like. One, some, any, or all of the processes described herein may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include, but are not limited to, a read only memory, a random access memory, a flash memory, a CD ROM, a DVD, a magnetic tape, a removable memory card, and a data storage device. In other embodiments, the computer-readable medium may be a transitory computer-readable medium. In such embodiments, the transitory computer-readable medium can be distributed over network coupled computer systems so that the computer-readable code may be stored and executed in a distributed fashion. For example, such a transitory computer-readable medium may be communicated from one electronic device to another electronic device using any suitable communications protocol (e.g., the computer-readable medium or any suitable portion thereof may be communicated amongst any suitable servers and/or devices to electronic device). Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal. It is to be understood that any, each, or at least one module or component or subsystem or server of the disclosure may be provided as a software construct, firmware construct, one or more hardware components, or a combination thereof. For example, any, each, or at least one module or component or subsystem or server of the disclosure may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules and servers and components and subsystems of the disclosure are merely illustrative, and that the number, configuration, functionality, and interconnection of existing modules, servers, components, and/or subsystems of the disclosure may be modified or omitted, additional modules, servers, components, and/or subsystems may be added, and the interconnection of certain modules, servers, components, and/or subsystems may be altered.

In various embodiments, program components may be developed using one or more programming languages, techniques, tools, and/or the like such as an assembly language, Ada, BASIC, C, C++, C#, F# (e.g., a functional programming language with advantageous programming capabilities for fast processing algorithms, such as may be used for any suitable process, such as process 900), COBOL, Fortran, Java, LabVIEW, Lisp, Mathematica, MATLAB, OCaml, PL/I, Smalltalk, Visual Basic for Applications (VBA), HTML, XML, CSS, JavaScript, JavaScript Object Notation (JSON), PHP, Perl, Ruby, Python, Asynchronous JavaScript and XML (AJAX), Simple Object Access Protocol (SOAP), SSL, ColdFusion, Microsoft .NET, Apache modules, Adobe Flash, Adobe AIR, Microsoft Silverlight, Windows PowerShell, batch files, Tel, graphical user interface (GUI) toolkits, SQL, database adapters, web application programming interfaces (APIs), application server extensions, integrated development environments (IDEs), libraries (e.g., object libraries, class libraries, remote libraries), remote procedure calls (RPCs), Common Object Request Broker Architecture (CORBA), and/or the like.

In some embodiments, components 840 may include an operating environment component 840a. The operating environment component may facilitate operation of the REP via various subcomponents.

In some implementations, the operating environment component may include an operating system subcomponent. The operating system subcomponent may provide an abstraction layer that may facilitate the use of, communication among, common services for, interaction with, security of, and/or the like of various REP coordinator elements, components, data stores, and/or the like.

In some embodiments, the operating system subcomponent may facilitate execution of program instructions (e.g., REP program instructions) by the processor by providing process management capabilities. For example, the operating system subcomponent may facilitate the use of multiple processors, the execution of multiple processes, multitasking, and/or the like.

In some embodiments, the operating system subcomponent may facilitate the use of memory by the REP. For example, the operating system subcomponent may allocate and/or free memory, facilitate memory addressing, provide memory segmentation and/or protection, provide virtual memory capability, facilitate caching, and/or the like. In another example, the operating system subcomponent may include a file system (e.g., File Allocation Table (FAT), New Technology File System (NTFS), Hierarchical File System Plus (HFS+), Universal Disk Format (UDF), Linear Tape File System (LTFS)) to facilitate storage, retrieval, deletion, aggregation, processing, generation, and/or the like of data.

In some embodiments, the operating system subcomponent may facilitate operation of and/or processing of data for and/or from input/output devices. For example, the operating system subcomponent may include one or more device drivers, interrupt handlers, file systems, and/or the like that allow interaction with input/output devices.

In some embodiments, the operating system subcomponent may facilitate operation of the REP coordinator as a node in a computer network by providing support for one or more communications protocols. For example, the operating system subcomponent may include support for the internet protocol suite (i.e., Transmission Control Protocol/Internet Protocol (TCP/IP)) of network protocols such as TCP, IP, User Datagram Protocol (UDP), Mobile IP, and/or the like. In another example, the operating system subcomponent may include support for security protocols (e.g., Wired Equivalent Privacy (WEP), Wi-Fi Protected Access (WPA), WPA2) for wireless computer networks. In yet another example, the operating system subcomponent may include support for virtual private networks (VPNs).

In some embodiments, the operating system subcomponent may facilitate security of the REP coordinator. For example, the operating system subcomponent may provide services such as authentication, authorization, audit, network intrusion-detection capabilities, firewall capabilities, antivirus capabilities, and/or the like.

In some embodiments, the operating system subcomponent may facilitate user interaction with the REP by providing user interface elements that may be used by the REP to generate a user interface. In one implementation, such user interface elements may include widgets (e.g., windows, dialog boxes, scrollbars, menu bars, tabs, ribbons, menus, buttons, text boxes, checkboxes, combo boxes, drop-down lists, list boxes, radio buttons, sliders, spinners, grids, labels, progress indicators, icons, tooltips, and/or the like) that may be used to obtain input from and/or provide output to the user. For example, such widgets may be used via a widget toolkit such as Microsoft Foundation Classes (MFC), Apple Cocoa Touch, Java Swing, GTK+, Qt, Yahoo! User Interface Library (YUI), and/or the like. In another implementation, such user interface elements may include sounds (e.g., event notification sounds stored in MP3 file format), animations, vibrations, and/or the like that may be used to inform the user regarding occurrence of various events. For example, the operating system subcomponent may include a user interface such as Windows Aero, Mac OS X Aqua, GNOME Shell, KDE Plasma Workspaces (e.g., Plasma Desktop, Plasma Netbook, Plasma Contour, Plasma Mobile), and/or the like.

In various embodiments the operating system subcomponent may include a single-user operating system, a multi-user operating system, a single-tasking operating system, a multitasking operating system, a single-processor operating system, a multiprocessor operating system, a distributed operating system, an embedded operating system, a real-time operating system, and/or the like. For example, the operating system subcomponent may include an operating system such as UNIX, LINUX, IBM i, Sun Solaris, Microsoft Windows Server, Microsoft DOS, Microsoft Windows 7, Microsoft Windows 8, Apple Mac OS X, Apple iOS, Android, Symbian, Windows Phone 7, Windows Phone 8, Blackberry QNX, and/or the like.

In some implementations, the operating environment component may include a database subcomponent. The database subcomponent may facilitate REP capabilities such as storage, analysis, retrieval, access, modification, deletion, aggregation, generation, and/or the like of data (e.g., the use of data stores 830). The database subcomponent may make use of database languages (e.g., Structured Query Language (SQL), XQuery), stored procedures, triggers, APIs, and/or the like to provide these capabilities. In various embodiments the database subcomponent may include a cloud database, a data warehouse, a distributed database, an embedded database, a parallel database, a real-time database, and/or the like. For example, the database subcomponent may include a database such as Microsoft SQL Server, Microsoft Access, MySQL, IBM DB2, Oracle Database, Apache Cassandra database, and/or the like.

In some implementations, the operating environment component may include an information handling subcomponent. The information handling subcomponent may provide the REP with capabilities to serve, deliver, upload, obtain, present, download, and/or the like a variety of information. The information handling subcomponent may use protocols such as Hypertext Transfer Protocol (HTTP), Hypertext Transfer Protocol Secure (HTTPS), File Transfer Protocol (FTP), Telnet, Secure Shell (SSH), Transport Layer Security (TLS), Secure Sockets Layer (SSL), peer-to-peer (P2P) protocols (e.g., BitTorrent), and/or the like to handle communication of information such as web pages, files, multimedia content (e.g., streaming media), applications, and/or the like.

In some embodiments, the information handling subcomponent may facilitate the serving of information to users, REP components, nodes in a computer network, web browsers, and/or the like. For example, the information handling subcomponent may include a web server such as Apache HTTP Server, Microsoft Internet Information Services (IIS), Oracle WebLogic Server, Adobe Flash Media Server, Adobe Content Server, and/or the like. Furthermore, a web server may include extensions, plug-ins, add-ons, servlets, and/or the like. For example, these may include Apache modules, IIS extensions, Java servlets, and/or the like. In some implementations, the information handling subcomponent may communicate with the database subcomponent via standards such as Open Database Connectivity (ODBC), Java Database Connectivity (JDBC), ActiveX Data Objects for .NET (ADO.NET), and/or the like. For example, the information handling subcomponent may use such standards to store, analyze, retrieve, access, modify, delete, aggregate, generate, and/or the like data (e.g., data from data stores 830) via the database subcomponent.

In some embodiments, the information handling subcomponent may facilitate presentation of information obtained from users, REP components, nodes in a computer network, web servers, and/or the like. For example, the information handling subcomponent may include a web browser such as Microsoft Internet Explorer, Mozilla Firefox, Apple Safari, Google Chrome, Opera Mobile, Amazon Silk, Nintendo 3DS Internet Browser, and/or the like. Furthermore, a web browser may include extensions, plug-ins, add-ons, applets, and/or the like. For example, these may include Adobe Flash Player, Adobe Acrobat plug-in, Microsoft Silverlight plug-in, Microsoft Office plug-in, Java plug-in, and/or the like.

In some implementations, the operating environment component may include a messaging subcomponent. The messaging subcomponent may facilitate REP message communications capabilities. The messaging subcomponent may use protocols such as Simple Mail Transfer Protocol (SMTP), Internet Message Access Protocol (IMAP), Post Office Protocol (POP), Extensible Messaging and Presence Protocol (XMPP), Real-time Transport Protocol (RTP), Internet Relay Chat (IRC), Skype protocol, AOL's Open System for Communication in Realtime (OSCAR), Messaging Application Programming Interface (MAPI), Facebook API, a custom protocol, and/or the like to facilitate REP message communications. The messaging subcomponent may facilitate message communications such as email, instant messaging, Voice over IP (VoIP), video conferencing, Short Message Service (SMS), web chat, in-app messaging (e.g., alerts, notifications), and/or the like. For example, the messaging subcomponent may include Microsoft Exchange Server, Microsoft Outlook, Sendmail, IBM Lotus Domino, Gmail, AOL Instant Messenger (AIM), Yahoo Messenger, ICQ, Trillian, Skype, Google Talk, Apple FaceTime, Apple iChat, Facebook Chat, and/or the like.

In some implementations, the operating environment component may include a security subcomponent that facilitates REP security. In some embodiments, the security subcomponent may restrict access to the REP, to one or more services provided by the REP, to data associated with the REP (e.g., stored in data stores 830), to communication messages associated with the REP, and/or the like to authorized users. Access may be granted via a login screen, via an API that obtains authentication information, via an authentication token, and/or the like. For example, the user may obtain access by providing a username and/or a password (e.g., a string of characters, a picture password), a personal identification number (PIN), an identification card, a magnetic stripe card, a smart card, a biometric identifier (e.g., a finger print, a voice print, a retina scan, a face scan), a gesture (e.g., a swipe), a media access control (MAC) address, an IP address, and/or the like. Various security models such as access-control lists (ACLs), capability-based security, hierarchical protection domains, and/or the like may be used to control access. For example, the security subcomponent may facilitate digital rights management (DRM), network intrusion detection, firewall capabilities, and/or the like.

In some embodiments, the security subcomponent may use cryptographic techniques to secure information (e.g., by storing encrypted data), verify message authentication (e.g., via a digital signature), provide integrity checking (e.g., a checksum), and/or the like by facilitating encryption and/or decryption of data. Furthermore, steganographic techniques may be used instead of or in combination with cryptographic techniques. Cryptographic techniques used by the REP may include symmetric key cryptography using shared keys (e.g., using one or more block ciphers such as triple Data Encryption Standard (DES), Advanced Encryption Standard (AES); stream ciphers such as Rivest Cipher 4 (RC4), Rabbit), asymmetric key cryptography using a public key/private key pair (e.g., using algorithms such as Rivest-Shamir-Adleman (RSA), Digital Signature Algorithm (DSA)), cryptographic hash functions (e.g., using algorithms such as Message-Digest 5 (MD5), Secure Hash Algorithm 2 (SHA-2)), and/or the like. For example, the security subcomponent may include a cryptographic system such as Pretty Good Privacy (PGP).

In some implementations, the operating environment component may include a virtualization subcomponent that facilitates REP virtualization capabilities. In some embodiments, the virtualization subcomponent may provide support for platform virtualization (e.g., via a virtual machine). Platform virtualization types may include full virtualization, partial virtualization, paravirtualization, and/or the like. In some implementations, platform virtualization may be hardware-assisted (e.g., via support from the processor using technologies such as AMD-V, Intel VT-x, and/or the like). In some embodiments, the virtualization subcomponent may provide support for various other virtualized environments such as via operating-system level virtualization, desktop virtualization, workspace virtualization, mobile virtualization, application virtualization, database virtualization, and/or the like. In some embodiments, the virtualization subcomponent may provide support for various virtualized resources such as via memory virtualization, storage virtualization, data virtualization, network virtualization, and/or the like. For example, the virtualization subcomponent may include VMware software suite (e.g., VMware Server, VMware Workstation, VMware Player, VMware ESX, VMware ESXi, VMware ThinApp, VMware Infrastructure), Parallels software suite (e.g., Parallels Server, Parallels Workstation, Parallels Desktop, Parallels Mobile, Parallels Virtuozzo Containers), Oracle software suite (e.g., Oracle VM Server for SPARC, Oracle VM Server for x86, Oracle VM VirtualBox, Oracle Solaris 10, Oracle Solaris 11), Informatica Data Services, Wine, and/or the like.

In some embodiments, components 840 may include a user interface component 840b. The user interface component may facilitate user interaction with the REP by providing a user interface. In various implementations, the user interface component may include programmatic instructions to obtain input from and/or provide output to the user via physical controls (e.g., physical buttons, switches, knobs, wheels, dials), textual user interface, audio user interface, GUI, voice recognition, gesture recognition, touch and/or multi-touch user interface, messages, APIs, and/or the like. In some implementations, the user interface component may make use of the user interface elements provided by the operating system subcomponent of the operating environment component. For example, the user interface component may make use of the operating system subcomponent's user interface elements via a widget toolkit. In some implementations, the user interface component may make use of information presentation capabilities provided by the information handling subcomponent of the operating environment component. For example, the user interface component may make use of a web browser to provide a user interface via HTML5, Adobe Flash, Microsoft Silverlight, and/or the like.

In some embodiments, components 840 may include any of the components NNG 840c, RVE 840d, RVP 840e described in more detail in preceding figures.

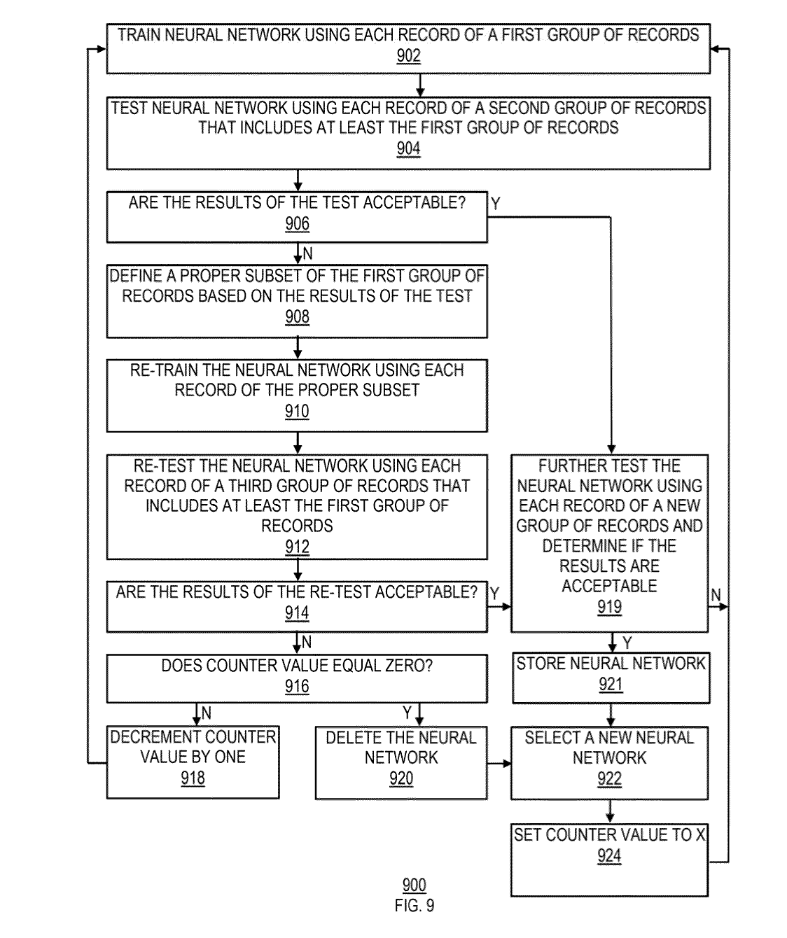

FIG. 9 is a flowchart of an illustrative process 900 for evaluating the performance of at least one neural network (e.g., as may be carried out by the REP). At step 902, process 900 may train a neural network using each record of a first group of records. For example, as described above with respect to FIG. 1, a neural network may be trained (e.g., at step 129) on a training data set (e.g., as may be determined at step 109). Next, at step 904, process 900 may test the neural network using each record of a second group of records, where that second group of records may include each record of the first group of records. For example, as described above with respect to FIG. 1, after being trained, a neural network may be tested (e.g., at step 137) on a testing data set (e.g., as may be determined at step 133). In some embodiments, the first group of records may be the same as the second group of records. In other embodiments, the first group of records may be a proper subset of the second group of records (e.g., every record of the first group is included in the second group but at least one record of the second group is not included in the first group). Next, at step 906, process 900 may determine if the results of the testing of step 904 are acceptable. For example, as described above with respect to FIG. 1, test results and/or the performance of a neural network may be analyzed (e.g., at step 141 and/or step 153 and/or step 169) to determine if the neural network is acceptable for use (e.g., if the average of the percentage testing errors of all records is less than a threshold amount). If the results of the test of step 904 are determined to be acceptable at step 906, process 900 may proceed to step 919 where the trained neural network may be tested using a new group of records (e.g., a group that includes at least one record that is not a part of the first group of records and/or a group that includes only records that are not a part of the first group of records such that the neural network may be tested using at least one record with which the neural network was not trained) and, if the results of the test of step 919 are determined to be acceptable (e.g., also at step 919 using the same or different acceptability threshold of step 906 (e.g., the average error percentage is less than 5% may be used as the acceptability threshold at each of steps 906 and 919 or an average error percentage of less than 5% may be used as the acceptability threshold at step 906 but an average error percentage of less than 8% may be used as the acceptability threshold at step 919, etc.)), process 900 may proceed to step 921 where the neural network may be stored for later use (e.g., as described below in more detail), yet, if the results of the test of step 919 are determined not to be acceptable (e.g., also at step 919), process 900 may return to step 902 where the trained neural network may be once again evaluated according to at least a portion of process 900. Otherwise, if the results of the test at step 904 are determined not to be acceptable at step 906, process 900 may proceed to step 908 where a proper subset of the first group of records may be defined based on the results of the test of step 906. For example, as described above with respect to FIG. 1, the worst performing subset (e.g., a strict or proper subset not equal to the complete training data set) of the training data set may be selected at step 157 of process 100. In some embodiments, the proper subset defined at step 908 may include each record from the first group of records that generated a test result with an error greater than the average error for all the records of the first group of records when tested on the neural network at step 904 (e.g., the subset may include only the records of the first group of records that performed below average during the test of step 906 (e.g., all records with a testing error higher than the averaged testing error)). In other embodiments, the proper subset defined at step 908 may be defined using any other suitable criteria with respect to the results of the performance test of step 906 (e.g., any suitable criteria other than using the records of the first group that performed below average, as described above). For example, in other embodiments, the proper subset defined at step 908 may be defined to include any suitable (e.g., predetermined) percentage (e.g., 20%) or any suitable number (e.g., 10) of records of the first group of records that gave the largest test result errors out of the entire first group of records at step 906. After the proper subset is defined at step 908, process 900 may proceed to step 910 where process 900 may train (e.g., re-train) the neural network using each record of the proper subset defined at step 908. It is to be understood, that while a single neural network may be referred to herein as being utilized during an iteration of steps 902-914, for example, a re-training (e.g., of step 910) may result in a “new” or “re-trained” neural network (e.g., the resulting re-trained neural network may include the same number of inputs and outputs and hidden layers of the neural network that was used for the re-training but the weights of the neural network may be changed during the re-training such that the re-trained neural network resulting from the re-training (e.g., of step 910) may include a different or modified weight matrix (e.g., weights, which may be at least a portion of C# object 236) than the neural network that was re-trained (e.g., the neural network resulting from the training of step 902). For example, as described above with respect to FIG. 1, a neural network may be re-trained (e.g., at step 161) on a subset of the training data set (e.g., as may be selected at step 157). One or more training methods or training learning algorithms may be used at step 910 to train the neural network using the records of the subset defined at step 908, where such one or more training methods may be the same as or different in any one or more ways from the one or more training methods that may have been used at step 902 to train the neural network using each record of the first group. Next, at step 912, process 900 may test (e.g., re-test) the neural network using each record of a third group of records, where that third group of records may include each record of the first group of records. For example, as described above with respect to FIG. 1, after being re-trained (e.g., at step 161), a neural network may be tested (e.g., at step 165) on a testing data set. In some embodiments, the first group of records may be the same as the third group of records. In other embodiments, the first group of records may be a proper subset of the third group of records (e.g., every record of the first group is included in the third group but at least one record of the third group is not included in the first group). In some embodiments, the third group of step 912 may be the same as the second group of step 904, or the third group may be different than the second group in any way. Next, at step 914, process 900 may determine if the results of the testing of step 912 are acceptable. For example, as described above with respect to FIG. 1, test results and/or the performance of a neural network may be analyzed (e.g., at step 141 and/or step 153 and/or step 169) to determine if the neural network is acceptable for use (e.g., if the average of the percentage testing errors of all tested records is less than a threshold amount). If the results of the test of step 912 are determined to be acceptable at step 914, process 900 may proceed to step 919 where the re-trained neural network may be tested using a new group of records (e.g., a group that includes at least one record that is not a part of the first group of records and/or a group that includes only records that are not a part of the first group of records such that the neural network may be tested using at least one record with which the neural network was not trained or re-trained) and, if the results of the test of step 919 are determined to be acceptable (e.g., also at step 919 using the same or different acceptability threshold of step 914 (e.g., the average error percentage is less than 5% may be used as the acceptability threshold at each of steps 914 and 919 or an average error percentage of less than 5% may be used as the acceptability threshold at step 914 but an average error percentage of less than 8% may be used as the acceptability threshold at step 919, etc.)), process 900 may proceed to step 921 where the neural network may be stored for later use (e.g., for use in a set of acceptable neural networks, such as in process 400 described above), yet, if the results of the test of step 919 are determined not to be acceptable (e.g., also at step 919), process 900 may return to step 902 where the re-trained neural network may be once again evaluated according to at least a portion of process 900. Otherwise, if the results of the test at step 914 are determined not to be acceptable at step 914, process 900 may proceed to step 916 where it may be determined whether a counter value is equal to zero or any other suitable value. If the counter is determined not to equal zero at step 916, the value of the counter may be decremented by one at step 918 and then process 900 may proceed back to step 902, whereby at least a portion of process 900 may be repeated in some manner (e.g., the re-trained neural network may be once again trained at step 902, once again tested at step 904, once again re-trained at step 910, and once again re-tested at step 912, whereby any of the training methods used at one or more of those steps during this next iteration may be the same or different than those used during the previous iteration of those steps, and/or whereby the criteria used to define the subset for the once again re-training step 910 may be the same as or different than the criteria used to define the subset for the previous re-training step (e.g., the subset defined at a first iteration of step 908 may be the worst performing 20% of the first group from the first test iteration of step 904, while the subset defined at a second iteration of step 908 may be the worst performing 10% of the first group from second test iteration of step 904, or both subsets may be defined at sequential iterations of step 908 by the same criteria (e.g., as the worst performing 20% from their respective iterations of step 904), but those two subsets may include different records from one another)). Alternatively, if the counter is determined to equal zero at step 916, the neural network that has been under training and testing may be deleted at step 920. After storage or deletion of the neural network (e.g., at step 920 or step 921), process 900 may proceed to step 922 where any suitable new neural network may be selected, after which the counter may be set to any suitable value “X”, and then the newly selected neural network may be used starting back at step 902 for evaluation according to at least a portion of process 900. Value X may be any suitable value (e.g., 10) for defining the potential (e.g., maximum) number of iterations of steps 902-914 during which a particular neural network may be evaluated (e.g., trained/tested) before which that neural network may be disposed of. In some embodiments, the value X may be determined as any suitable number such that any number of iterations of the process above that value may not result in the lowering of a testing error. In some embodiments, rather than using a counter value X, the process may be repeated until the testing error is not lowered between successive iterations of the process (e.g., if the results of the most recent iteration of step 912 are not better than the results of the previous iteration of step 912, then step 916 may proceed to step 920 rather than back to step 902 (e.g., without a step 918)). Alternating the training methods, for example, by using primary and secondary training algorithms during the same training session (e.g., during a single iteration of steps 902-914 and/or during different iterations of steps 902-914 may improve the effectiveness of process 900. When a primary algorithm (e.g., BackPropagation) is no longer improving the evaluation of a neural network, a secondary algorithm (e.g., Resilient Propagation and/or Levenberg-Marquardt) may be used. Such a combination may often help the propagation process(es) to escape a local minimum. Re-initializing an input weights matrix (e.g., after a number of epochs if the error is not lowering during the training session) may be productive (e.g., at steps 920/922). It is understood that the steps shown in process 900 of FIG. 9 are merely illustrative and that existing steps may be modified or omitted, additional steps may be added, and the order of certain steps may be altered.

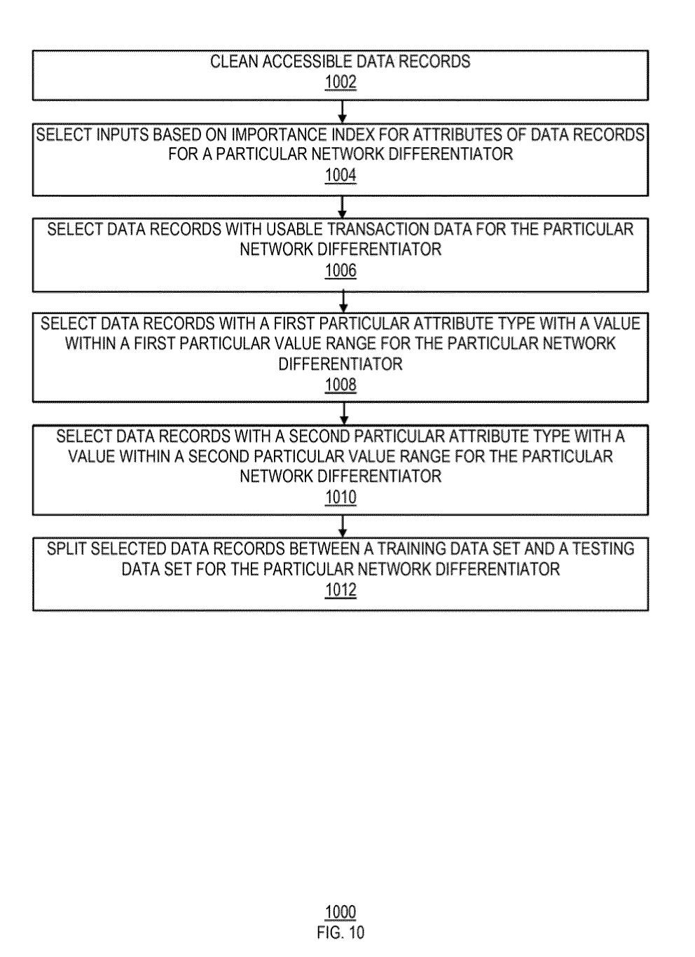

FIG. 10 is a flowchart of an illustrative process 1000 for determining a data set (e.g., a training data set and/or a testing data set) for use in generating a neural network for a particular network differentiator (e.g., as may be carried out by the REP (e.g., at step 109 and/or step 133 of process 100 described above)). At step 1002, process 1000 may clean up one or more accessible data records. Such cleaning may include any suitable validating, eliminating, correcting, adding, or otherwise acting on any suitable values of any suitable data record accessible by the REP (e.g., from any suitable historical data that may be collected, as described above (e.g., from the data sets data store 830d)). For example, a data record may include property characteristics (e.g., square footage, number of bedrooms, number of bathrooms, etc.), neighborhood characteristics, geographic localization (e.g., state, city, borough, area, neighborhood, etc.), transactions data (e.g., transaction date, listed price, sold price, days on the market, description, etc.), trends data (e.g., seasonal and/or annual price change trends, average days on the market, information concerning supply and demand for real estate, etc.), economic data (e.g., consumer confidence levels, gross domestic product, interest rates, stock market values, anticipated future housing supply levels, wage growth, etc.), and/or the like. Historical data may contain the transactions recorded on a specific unit but also the description of the building and the unit. By importing multiple transactions about the same unit, the REP may be operative to complete missing information to correct inaccurate information or to apply changes to the unit characteristics (e.g., a unit was transformed from 3 bedrooms to only 2 bedrooms). Cleaning of step 1002 may include recovering a missing value from a particular record. For example, the REP may generate (e.g., train and test) a neural network that may be designed to estimate square footage of a unit given any suitable inputs, and such a neural network may then be used to estimate a missing square footage value of a particular record using other attribute values of that record as inputs to the neural network. As another example, cleaning of step 1002 may include eliminate erroneous values from one or more records (e.g., as may be caused by erroneous user data entry, data conversion, or even transaction data with false declared values (e.g., the sale of a condo could be declared for $10 despite the value being much greater). The REP may be operative to run any suitable algorithm(s) or process(es) for eliminating as many erroneous values as possible from accessible records. As just one example, the following steps may be taken by the REP to eliminate erroneous values from records or eliminate records with erroneous values from use in generating a neural network: (1) create one or more value ranges (e.g., 0-100, 101-200, 201-300, 301-400, 401-500, 501-600, etc.) for the values of each record being analyzed for this process for a particular attribute (e.g., square footage); (2) from the data set, eliminate values that have no sense (e.g., any square footage less than 1 or any recorded sale price less than $1000 or greater than $500,000,000); (3) define the minimum number of records that must be in a particular created value range (e.g., more than 10 records for a particular value range (e.g., if over 100 records being used)) such that value ranges may be identified that have the best representation; (4) calculate the number of records in each of these ranges (e.g., each range defined in (1)); (5) select only the values from the ranges with the best representation (e.g., with at least 10 records represented therein); (6) calculate the average of the values from all of the selected values (e.g., selected at (5)); (7) calculate the standard deviation to define the dispersion from the average calculated at (6) (e.g., the normal distribution); and then (8) eliminate all values that were not selected at (5) and that eliminate all the values selected at (5) that are outside of the standard deviation interval calculated at (7), such that the remaining values are the ones that are relied upon in the records available to the REP. Next, at step 1004, process 1000 may select inputs (e.g., attribute types) for the data set being defined by process 1000 based on an importance index for one or more attributes of one or more data records for a particular network differentiator. A network differentiator may be indicative of the focus or use case for a neural network to be created. For example, as mentioned, a neural network may be specifically generated (e.g., specifically trained and tested) for use in producing an output (e.g., an estimated value output) for a particular type of property unit (e.g., with one or more attributes or attribute ranges) and/or for a particular period of time (e.g., a first network differentiator for a first neural network may be “estimate current sale value between $400,000-$599,999 of a condominium in location A with 501-1000 square feet”, while a second network differentiator for a second neural network may be “estimate current sale value between $600,000-$799,99 of a condominium in location A with 501-1000 square feet”, while a third network differentiator for a third neural network may be “estimate past sale value from 3-6 months ago for a condominium in location B with 501-1000 square feet”, while a fourth network differentiator for a fourth neural network may be “estimate past sale value from 6-9 months ago for a condominium in location B with 501-1000 square feet”, etc.). Therefore, given a particular network differentiator, the training data set used for generating a neural network for that particular network differentiator may be selected specifically (e.g., by process 1000) based on that particular network differentiator. Therefore, at step 1004, an importance index may be generated and/or leveraged for the attributes of the accessible data records, where such an importance index may assign an importance factor to one or more attributes of the data records, where such importance factors may vary based on the particular network differentiator (e.g., as mentioned above, the importance factor of square footage may be higher than the importance factor of a doorman with respect to condominiums in densely populated cities while the importance factor of square footage may be lower than the importance factor of a doorman with respect to condominiums in suburban areas). The importance index may be leveraged to select a particular number of attribute types of the property records data as inputs for the data set being defined by process 1000 (e.g., 10 attribute types), where such selection may be based on the attributes with the highest importance factors for the particular network differentiator. A number of attributes with lower importance factors for a given differentiator may be combined or grouped into a single attribute with a higher importance factor that may be selected at step 1004 (e.g., grouping as described above with respect to process 100). The number of inputs used for a data set for use in training and/or testing a neural network may be an important parameter, while the type of each input (e.g., its importance) may also be very important for the effectiveness of the data set. A neural network trained on a data set with 5 inputs can have better performances that another neural network trained on a data set also with 5 inputs but different unit characteristics (e.g., input importance factors). To each unit characteristic (e.g., data record attribute) an importance factor of a certain import may be assigned (e.g., in the importance index). The data set may not only be defined by the number of inputs but also by the global importance factor of the inputs selected. The importance factor of an input can also vary based on the unit localization or any other suitable attributes of a record for a neural network of a particular network differentiator. Some building amenities may not be so important if the building is located in downtown but can become more important for buildings located in the suburbs. Multiple inputs with low importance factors can be grouped (e.g., with any suitable concatenation formula) to create a new input with a higher combined importance factor. Next, at step 1006, process 1000 may select or isolate from the accessible data records only the data records with usable transaction data for the particular network differentiator. For example, if the network differentiator is for “estimating past sale value from 6-9 months ago for a condominium in location B with 501-1000 square feet”, only the data records with transaction data indicative of a sale price within the range from 6-9 months ago may be isolated at step 1006 for further use in process 1000. Next, at step 1008, process 1000 may select or isolate from the currently selected data records (e.g., from all accessible data records or from only those selected at step 1006) only the data records with a first particular type of attribute with a value within a first particular value range. The selection of step 1008 may be made based on a first particular network differentiator, such as based on the intended supervised output of the particular network differentiator. For example, if the particular network differentiator is for “estimating current sale value between $400,000-$599,999 of a condominium in location A with 501-1000 square feet”, only the available data records with transaction data indicative of a recent (e.g., current) sale price within the range of $400,000-$599,999 may be selected at step 1008 for further use in process 1000. As another example, if the network differentiator is for “estimating current sale value between $600,000-$799,999 of a condominium in location A with 501-1000 square feet”, only the available data records with transaction data indicative of a recent (e.g., current) sale price within the range of $600,000-$799,999 may be selected at step 1008 for further use in process 1000. In other embodiments, the selection of step 1008 may be made based on another suitable type of particular network differentiator, such as based on an input attribute type that may be particularly associated with a particular range of an intended supervised output of the particular network differentiator. For example, if the particular network differentiator is for “estimating current sale value between $400,000-$599,999 of a condominium in location A with 501-1000 square feet”, only the available data records with an input attribute (e.g., geographic zone of the real estate property) that is associated with a recent (e.g., current) sale price within the range of $400,000-$599,999 may be selected at step 1008 for further use in process 1000. For example, two or more geographic zones (e.g., two or more neighborhoods or any other quantifiable location-based attribute that may later be defined by the user as an input value to an estimating neural network) may be grouped together (e.g., as a “location A”), where each record that has a geographic zone attribute value of any geographic zone of that grouped location A may also have a sale price attribute value within a particular range of output values (e.g., current sale price values within the range of $400,000-$599,999), such that the records from each of those two geographic zones (e.g., each record with a geographic zone attribute having one of at least two values associated with one of the at least two geographic zones grouped based on similar price value ranges) may be selected at step 1008. Therefore, rather than selecting all records that have a sale price attribute value within a particular range (e.g., within the range of $400,000-$599,999), step 1008 may be operative to select all records that have a geographic zone attribute value indicative of one of at least two or more geographic zones that may be grouped (e.g., by the REP) based on the similarity between the sale price attribute values of those two or more geographic zones. This may limit the output value of each record of a data set used to train/test a particular neural network to a particular range (e.g., $400,000-$599,999) while doing so in relation tone or more particular input values of each record (e.g., a geographic zone input value associated with a grouping of geographic zone input values that are associated with that output value range. By grouping together geographic zones with similar ranges of output values, the REP may be operative to limit the output variation of a neural network. If each record of a first geographic zone (e.g., neighborhood 1) is determined to have a sale price between 5450,000 and $599,999 and each record of a second geographic zone (e.g., neighborhood 2) is determined to have a sale price between $400,000 and $550,000, while each record of a third geographic zone (e.g., neighborhood 3) is determined to have a sale price between $300,000 and $399,999, the REP may be operative to group each record of the first and second geographic zones but not of the third geographic zone into a first grouping (e.g., location A) such that the output variation of all records of grouping A may be limited to $400,000-$599,999, and a data set may be created (e.g., during process 1000) for use in generating a particular neural network based on such a selection at step 1008. Therefore, a limitation of the output variation may be indirectly controlled by the grouping of selected geographic zone input attribute values. Then, when a user provides one or more input attribute values for use by a neural network (e.g., for use in estimating a sale price of a property), at least one of such input attribute values may identify a particular geographic zone and a neural network that may previously have been generated using a data set restricted to records (e.g., at step 1008) based on a grouped location including that particular geographic zone may then be selected by the REP for use on those user supplied input values. Next, at step 1010, process 1000 may select or isolate from the currently selected data records (e.g., from all accessible data records or from only those selected at step 1006 and/or at step 1008) only the data records with a second particular type of attribute with a value within a second particular value range. The selection of step 1010 may be made based on a second particular network differentiator, such as based on any selected input (e.g., of the inputs selected at step 1004). For example, if the particular network differentiator is for “estimating current sale value between $400,000-$599,999 of a condominium in location A with 501-1000 square feet”, only the available data records with unit characteristic data indicative of a unit with square footage within the range of 500-1000 square feet may be selected at step 1010 for further use in process 1000. As another example, if the particular network differentiator is for “estimating current sale value between $400,000-$599,999 of a condominium in location A with 1001-1500 square feet”, only the available data records with unit characteristic data indicative of a unit with square footage within the range of 1001-1500 square feet may be selected at step 1010 for further use in process 1000. It is to be understood that, while the selection of step 1008 may be made based on any output of the particular network differentiator (e.g., estimated value output) and while the selection of step 1010 may be made based on any input of the particular network differentiator (e.g., of the inputs selected at step 1004, such as square footage), step 1008 may instead be based on any input and step 1010 may be based on an output. Next, at step 1012, process 1000 may split the currently selected data records (e.g., those data records selected at step 1006 and/or at step 1008 and/or at step 1010 (e.g., the data records that were selected by each one of steps 1006, 1008, and 1010) into at least a training data set and a testing data set. The split may be done according to any suitable criteria, such as 70% of the records being associated with a training data set for the particular network differentiator and the remaining 30% of the records being associated with a testing data set for the particular network differentiator. For example, the training data set defined at step 1012 of process 1000 may be used at step 109 of process 100 and/or at step 902 of process 900 when the REP is generating a neural network based on the particular network differentiator. Additionally or alternatively, for example, the testing data set defined at step 1012 of process 1000 may be used at step 133 of process 100 and/or at step 919 of process 900 when the REP is generating a neural network based on the particular network differentiator. One or more of the steps of process 1000 may be repeated for any suitable new particular network differentiator. For example, after step 1012, process 1000 may return to step 1010 and step 1010 may be repeated for the second particular attribute type but with a value within a third particular range for a new particular network differentiator (e.g., if the initial particular network differentiator for steps 1002-1012 is for “estimating current sale value between $400,000-$599,999 of a condominium in location A with 501-1000 square feet”, then repeating step 1010 may be a selection done for a new particular network differentiator that may be for “estimating current sale value between $400,000-$599,999 of a condominium in location A with 1001-1500 square feet” (rather than 501-1000 square feet)), but otherwise a selection from the same records available at the first iteration of step 1010. As another example, after step 1012, process 1000 may return to step 1008 and step 1008 may be repeated for the first particular attribute type but with a value within a fourth particular range for a new particular network differentiator (e.g., if the initial particular network differentiator for steps 1002-1012 is for “estimating current sale value between $400,000-$599,999 of a condominium in location A with 501-1000 square feet”, then repeating step 1008 may be a selection done for a new particular network differentiator that may be for “estimating current sale value between $600,000-$799,999 of a condominium in location B with 501-1000 square feet” (rather than in location A with $400,000-$599,000)), but otherwise a selection from the same records available at the first iteration of step 1008, where in such an example, step 1010 may then be repeated for one or more other particular attribute ranges for the second particular attribute type (e.g., 1001-1500 square feet). As another example, after step 1012, process 1000 may return to step 1006 and step 1006 may be repeated for a new particular network differentiator (e.g., if the initial particular network differentiator for steps 1002-1012 is for “estimating past sale value from 6-9 months ago for a condominium with 501-1000 square feet”, then repeating step 1006 may be a selection done for a new particular network differentiator that may be for “estimating past sale value from 3-6 months ago for a condominium with 501-1000 square feet” (rather than 6-9 months)), such that a next iteration of process 1006-1012 may define training and testing data sets for a neural network associated with a different slice estimation time period (e.g., as described above). Therefore, process 1000 may be operative to enable the REP to define any suitable testing data set and/or training data set for any suitable neural network with any suitable particular network differentiator. Through analyzing the dependency between a network performances and variation of the output, the following conclusion may be drawn: limiting the number of patterns that a neural network must recognize may drastically improve the network performances. Limiting the number of characteristics that a network must identify for each pattern may also considerably improve the performances. In other words, training a specialized network will result in a set of networks with high performances, very capable to recognize the patterns trained therefor. Therefore, a network trained on units with similar characteristics and limited ranges for inputs and or output may be high performing. It is understood that the steps shown in process 1000 of FIG. 10 are merely illustrative and that existing steps may be modified or omitted, additional steps may be added, and the order of certain steps may be altered.

For example, as mentioned above (e.g., with respect to FIG. 5), a first estimating neural network may be specially designed (e.g., trained and tested) for providing an estimated value of a property from 3 months ago (e.g., an estimated value of the property within the time frame between 3 and 6 months ago) and a second estimating neural network may be specially designed (e.g., trained and tested) for providing an estimated value of a property from 6 months ago (e.g., an estimated value of the property within the time frame between 6 and 9 months ago) and a third estimating neural network may be specially designed (e.g., trained and tested) for providing an estimated value of a property from 9 months ago (e.g., an estimated value of the property within the time frame between 9 and 12 months ago), and the output of each of such three estimating neural networks may be provided as a particular input to a predicting neural network that may provide a prediction of a value of a property in the future (e.g., 3 months from now). A system may include a feedforward neural network that may be configured to receive feedforward inputs and generate a feedforward output. For example, as described above with respect to process 100 and process 400, an estimating neural network may be generated as a feedforward neural network and may be used to provide an estimated output (e.g., an estimated value for a real estate property). The system may also include a recurrent neural network that may be configured to receive a number of recurrent inputs and to generate a recurrent output. For example, as described above with respect to process 100 and process 500, a predicting neural network may be generated as a recurrent neural network and may be used to provide a predicted output (e.g., a predicted future value for a real estate property). In such a system, one of the recurrent inputs of the recurrent inputs may include the feedforward output. For example, as describe above with respect to process 500, an output of an estimating neural network (e.g., a value obtained at step 505 and/or at step 525) may be used as an input to a predicting neural network (e.g., at steps 529-541). Moreover, in such a system, the feedforward output may be an estimated value of an item for one of a current time and a previous period of time, while the recurrent output may be a predicted value of the item for a future period of time (e.g., as described above with respect to process 500). In some embodiments, the item may be a real estate property. Alternatively or additionally, in some embodiments, such a system may also include another feedforward neural network that may be configured to receive other feedforward inputs and generate another feedforward output, wherein another one of the recurrent inputs of the number of recurrent inputs may include the other feedforward output, wherein the feedforward output may be the estimated value of the item for the previous period of time and the other feedforward output is an estimated value of the item for another previous period of time that is different than the previous period of time. For example, as described above, a first input to a predicting neural network may be the output of a first estimating neural network (e.g., that may be an estimate of a value at a first previous time frame (e.g., the value of a property 3-6 months ago), while a second input to the predicting neural network may be the output of a second estimating neural network (e.g., that may be an estimate of a value at a second previous time frame (e.g., the value of a property 6-9 months ago), where each of the two estimating neural networks may have different structures, may have been trained/tested on different data sets, and the like (e.g., may be associated with different particular network differentiators, such as described above with respect to process 1000). For example, in some embodiments, the output of one of the estimating neural networks may be provided as an input to another one of the estimating neural networks as well as to an input to the predicting neural network. The data set used to train the two neural networks may have different structures. For example, a feedforward (e.g., estimating) neural network may be trained by a data set rich on real estate property characteristics, with a lot of information about the unit description, neighborhood, localization, and amenities. The data set used to train the recurrent (e.g., predicting) neural network may be trained by a data set with historical data on information on price variation, days on the market, mortgage rates, consumer confidence indices and other economic factors. When creating the time series of the price variation in time for the recurrent neural network, when the price parameter is missing for a time unit, a set of feedforward (e.g., estimating) neural networks can be used for price estimation and output may then used by a recurrent network for price prediction. Inside of each set of neural networks, the networks can be interconnected using a collaboration module. Because a neural network may only have one output, when an input parameter is missing for prediction, this parameter can be output by another neural network. For example, to predict the number of days the unit will stay on the market, one of the input parameters may be the predicted price so the output of a price prediction neural network may be used as an input for the number of days on the market prediction neural network.

### The Embodiments of the Rep

The entirety of this disclosure (including the written description, figures, claims, abstract, and/or the like) for REAL ESTATE EVALUATING PLATFORM METHODS, APPARATUSES, AND MEDIA shows various embodiments via which the claimed innovations may be practiced. It is to be understood that these embodiments and the features they describe may be a representative sample presented to assist in understanding the claimed innovations, and are not exhaustive and/or exclusive. As such, the various embodiments, implementations, examples, and/or the like are deemed non-limiting throughout this disclosure. Furthermore, alternate undescribed embodiments may be available (e.g., equivalent embodiments). Such alternate embodiments have not been discussed in detail to preserve space and/or reduce repetition. That alternate embodiments have not been discussed in detail is not to be considered a disclaimer of such alternate undescribed embodiments, and no inference should be drawn regarding such alternate undescribed embodiments relative to those discussed in detail in this disclosure. It is to be understood that such alternate undescribed embodiments may be utilized without departing from the spirit and/or scope of the disclosure. For example, the organizational, logical, physical, functional, topological, and/or the like structures of various embodiments may differ. In another example, the organizational, logical, physical, functional, topological, and/or the like structures of the REP coordinator, REP coordinator elements, REP data stores, REP components and their subcomponents, capabilities, applications, and/or the like described in various embodiments throughout this disclosure are not limited to a fixed operating order and/or arrangement, instead, all equivalent operating orders and/or arrangements are contemplated by this disclosure. In yet another example, the REP coordinator, REP coordinator elements, REP data stores, REP components and their subcomponents, capabilities, applications, and/or the like described in various embodiments throughout this disclosure may not be limited to serial execution, instead, any number and/or configuration of threads, processes, instances, services, servers, clients, nodes, and/or the like that may execute in parallel, concurrently, simultaneously, synchronously, asynchronously, and/or the like is contemplated by this disclosure. Furthermore, it is to be understood that some of the features described in this disclosure may be mutually contradictory, incompatible, inapplicable, and/or the like, and are not present simultaneously in the same embodiment. Accordingly, the various embodiments, implementations, examples, and/or the like are not to be considered limitations on the disclosure as defined by the claims or limitations on equivalents to the claims.

This disclosure includes innovations not currently claimed. Applicant reserves all rights in such currently unclaimed innovations including the rights to claim such innovations and to file additional provisional applications, nonprovisional applications, continuation applications, continuation-in-part applications, divisional applications, and/or the like. It is to be understood that while some embodiments of the REP discussed in this disclosure have been directed to urban real estate, the innovations described in this disclosure may be readily applied to a wide variety of other fields and/or applications.

1. An apparatus for generating a real estate value estimating neural network, comprising:
a memory; and
a processor in communication with the memory, and configured to issue a plurality of processing instructions stored in the memory, wherein the processor issues instructions to:
obtain by the processor a real estate unit type selection;
determine by the processor a training data set based on the real estate unit type, wherein the training data set comprises records associated with real estate properties of the real estate unit type;
train by the processor a real estate value estimating neural network using the training data set;
determine by the processor a testing data set based on the real estate unit type, wherein the testing data set comprises records associated with real estate properties of the real estate unit type;
test by the processor the real estate value estimating neural network on the testing data set;
establish by the processor, based on the testing, that the real estate value estimating neural network's performance is not acceptable;
determine by the processor the worst performing subset of the training data set; and
retrain by the processor the real estate value estimating neural network on the worst performing subset of the training data set.

2. An apparatus for generating a set of real estate value estimating neural networks, comprising:
a memory; and
a processor in communication with the memory, and configured to issue a plurality of processing instructions stored in the memory, wherein the processor issues instructions to:
obtain by the processor a real estate unit type selection;
determine by the processor a training data set based on the real estate unit type, wherein the training data set comprises records associated with real estate properties of the real estate unit type;
train by the processor a plurality of real estate value estimating neural networks on the training data set;
determine by the processor a testing data set based on the real estate unit type, wherein the testing data set comprises records associated with real estate properties of the real estate unit type;
test by the processor the plurality of real estate value estimating neural networks on the testing data set;
select by the processor, based on the testing, from the plurality of real estate value estimating neural networks a subset of the best performing neural networks to create a set of real estate value estimating neural networks; and
retrain by the processor each neural network in the set of real estate value estimating neural networks on the worst performing subset of the training data set for the respective neural network.

3. The apparatus of claim 2, wherein the processor further issues instructions to:
obtain by the processor historical data regarding a plurality of real estate properties for an estimation time frame;
select by the processor a first subset of the historical data that comprises real estate properties that have data regarding property values during the estimation time frame from the obtained historical data;
slice by the processor the first subset of the historical data into slices for each estimation time period;
generate by the processor a first set of neural networks using a slice as a first data set;
determine by the processor the best performing subset of the first data set;
determine by the processor real estate properties from the historical data comparable with the best performing subset of the first data set;
estimate by the processor property values of the comparable real estate properties using the first set of neural networks; and
utilize by the processor the estimated property values as part of historical data used in the training data set.

4. The apparatus of claim 3, wherein the processor further issues instructions to:
generate by the processor a second set of neural networks using a plurality of slices augmented with the estimated property values as a second data set;
predict by the processor property values of real estate properties from the historical data using the second set of neural networks; and
utilize by the processor the predicted property values as part of historical data used in the training data set.

5. The apparatus of claim 2, wherein:
the records in the training data set comprise attribute values for a plurality of attributes associated with real estate properties of the real estate unit type; and
the plurality of real estate value estimating neural networks are trained using specified attributes from the plurality of attributes as inputs.

6. The apparatus of claim 5, wherein at least some of the specified attributes are grouped into at least one group input.

7. The apparatus of claim 6, wherein:
the specified attributes are grouped based on attribute importance factor for each attribute; and
attribute importance factor for an attribute is indicative of the attribute's capacity to lower output error.

8. The apparatus of claim 7, wherein attribute importance factor for an attribute is determined using data mining techniques based on neural network output error screening.

9. The apparatus of claim 5, wherein the attribute values are converted into numerical values using referential tables and normalized.

10. The apparatus of claim 2, wherein each of the plurality of real estate value estimating neural networks is initialized using a randomly created weights matrix.

11. The apparatus of claim 2, wherein the records in the training data set are ordered randomly.

12. The apparatus of claim 2, wherein a first training method is used for training and a second training method is used for retraining.

13. The apparatus of claim 12, wherein the first training method and the second training method are the same.

14. The apparatus of claim 2, wherein the processor further issues instructions to determine an overall performance level for the set of real estate value estimating neural networks.

15. An apparatus for evaluating real estate property value, comprising:
a memory; and
a processor in communication with the memory, and configured to issue a plurality of processing instructions stored in the memory, wherein the processor issues instructions to:
obtain over a network property attribute values associated with a real estate property;
determine by the processor a real estate unit type based on the obtained property attribute values;
select by the processor an appropriate set of real estate value estimating neural networks based on the real estate unit type;
estimate by the processor component property values for the real estate property by using each neural network in the selected set of real estate value estimating neural networks to estimate a property value for the real estate property; and
calculate by the processor an overall estimated property value for the real estate property based on the estimated component property values.

16. The apparatus of claim 15, wherein the overall estimated property value is one of: estimated property price for the real estate property, and estimated rental price for the real estate property.

17. The apparatus of claim 15, wherein the processor further issues instructions to:
select by the processor a first set of real estate value predicting neural networks based on the real estate unit type;
predict by the processor, based on the overall estimated property value, first component values for the real estate property by using each neural network in the first set of real estate value predicting neural networks to predict a value for the real estate property; and
calculate by the processor a first overall predicted value for the real estate property based on the predicted first component values.

18. The apparatus of claim 17, wherein the processor further issues instructions to:
select by the processor a second set of real estate value predicting neural networks;
predict by the processor, based on the first overall predicted value, second component values for the real estate property by using each neural network in the second set of real estate value predicting neural networks to predict a value for the real estate property; and
calculate by the processor a second overall predicted value for the real estate property based on the predicted second component values.

19. The apparatus of claim 18, wherein one of the first overall predicted value and the second overall predicted value is one of: the direction of the market, price of the real estate property in the future, expected number of days on the market for the real estate property, and suggested asking price for the real estate property.

20. The apparatus of claim 15, wherein the processor further issues instructions to:
generate a display signal configured to form the basis for a visual display, wherein the visual display comprises visual representations of: the overall estimated property value for the real estate property and at least one of predicted time on the market for the real estate property, suggested asking price for the real estate property, and information regarding real estate properties comparable with the real estate property; and
transmit the display signal over a network.

21.-53. (canceled)
